(19) United States
(12) Patent Application Publication
(10) Pub. No.: US 2025/0119566 A1
(43) Pub. Date: Apr. 10, 2025

(54) VIDEO DECODERS AND METHODS FOR LOW-LATENCY DECODING

(71) Applicant: NOVATEK Microelectronics Corp., Hsin-Chu (TW)

(72) Inventors: Kuan-Lin Chiu, Hsinchu City (TW); Kuan-Hsien Wu, Hsinchu County (TW); Yen-Ju Huang, Hsinchu County (TW); Yun-Da Wu, Hsinchu County (TW)

(73) Assignee: NOVATEK Microelectronics Corp., Hsin-Chu (TW)

(21) Appl. No.: 18/889,357

(22) Filed: Sep. 18, 2024

Related U.S. Application Data
(60) Provisional application No. 63/542,298, filed on Oct. 4, 2023.

(51) Int. Cl. H04N 19/44; H04N 19/119; H04N 19/136; H04N 19/172; H04N 19/174; H04N 19/184

(52) U.S. Cl. CPC H04N 19/44; H04N 19/119; H04N 19/136; H04N 19/172; H04N 19/174; H04N 19/184

(57) ABSTRACT

A method of decoding a picture frame from a bitstream includes grouping N tiles of the picture frame into P sub-pictures, the P sub-pictures being non-overlapping with each other, a first sub-picture of the P sub-pictures comprising Q columns of tiles, N being an integer exceeding 1, P, Q being positive integers, and partitioning a first column of tiles of the Q columns of tiles into M sub-slices, the M sub-slices being non-overlapping with each other, M being an integer exceeding 1. The method further includes obtaining first tile information from a memory prior to decoding a current sub-slice of the M sub-slices, a first processor decoding the current sub-slice of the M sub-slices according to the first tile information, and storing second tile information in the memory upon completion of decoding the current sub-slice of the M sub-slices.

### CROSS REFERENCE TO RELATED APPLICATIONS

This application claims the benefit of U.S. Provisional Application No. 63/542,298, filed on Oct. 4, 2023. The content of the application is incorporated herein by reference.

### BACKGROUND OF THE INVENTION

### 1. FIELD OF THE INVENTION

The invention relates to video processing, and in particular, to video decoders and methods for low-latency decoding.

### 2. DESCRIPTION OF THE PRIOR ART

A video decoder is a device for converting encoded (compressed) video stream from a video encoder into raw (uncompressed) video stream for display. The video decoder is widely used in display devices such as smart phones, laptop computers, desktop computers, gaming consoles, and others.

The video encoder/decoder (codec) can adopt video encoding/decoding techniques as those specified in tile-based video coding standards such as high efficiency video coding (HEVC) standard. In the tile-based video coding standards, a picture is partitioned into one or more tiles, and each tile contains a group of largest coding units (LCU) that can be encoded or decoded independently of another tile. In general, the tiles of the picture are decoded sequentially from left to right and top to bottom, that is, in a tile-based raster order. The pixels of the picture are displayed sequentially from left to right and top to bottom, that is, in a pixel-based raster order. Since the shapes of the tiles are different from full rows of pixels, the decoding order can be different from the display order, and the display device cannot display pixels of the picture until one or more rows of pixels are decoded, resulting in an increase in display latency.

### SUMMARY OF THE INVENTION

According to an embodiment of the invention, a method of decoding a picture frame from a bitstream includes grouping N tiles of the picture frame into P sub-pictures, the P sub-pictures being non-overlapping with each other, a first sub-picture of the P sub-pictures comprising Q columns of tiles, N being an integer exceeding 1, P, Q being positive integers, and partitioning a first column of tiles of the Q columns of tiles into M sub-slices, the M sub-slices being non-overlapping with each other, M being an integer exceeding 1. The method further includes obtaining first tile information from a memory prior to decoding a current sub-slice of the M sub-slices, a first processor decoding the current sub-slice of the M sub-slices according to the first tile information, and storing second tile information in the memory upon completion of decoding the current sub-slice of the M sub-slices.

According to another embodiment of the invention, a video decoder of decoding a picture frame from a bitstream includes a sub-picture circuit, a sub-slice circuit, a memory controller, and a first processor. The sub-picture circuit groups N tiles of the picture frame into P sub-pictures, the P sub-pictures being non-overlapping with each other, a first sub-picture of the P sub-pictures comprising Q columns of tiles, N being an integer exceeding 1, P, Q being positive integers. The sub-slice circuit is coupled to the sub-picture circuit to partition a first column of tiles of the Q columns of tiles into M sub-slices, the M sub-slices being non-overlapping with each other, M being an integer exceeding 1. The memory controller coupled to a memory to obtain first tile information from the memory prior to decoding a current sub-slice of the M sub-slices. The first processor coupled to the sub-slice circuit and the memory controller to decode the current sub-slice of the M sub-slices according to the first tile information. The memory controller further stores second tile information in the memory upon completion of decoding the current sub-slice of the M sub-slices.

According to another embodiment of the invention, a method of decoding a picture frame from a bitstream includes partitioning Q columns of tiles into S sub-slices, the S sub-slices containing k sets of Q sub-slices, each set of Q sub-slices being partitioned from a first column to a Qth column, the S sub-slices being non-overlapping with each other, obtaining first tile information from a memory prior to decoding a current sub-slice of the S sub-slices, a processor decoding the current sub-slice of the S sub-slices according to the first tile information, and storing second tile information in the memory upon completion of decoding the current sub-slice of the S sub-slices, Q, k being positive integers, S being an integer exceeding 1.

According to another embodiment of the invention, a method of decoding a picture frame from a bitstream includes grouping N tiles of the picture frame into P sub-pictures, the P sub-pictures being non-overlapping with each other, a first sub-picture of the P sub-pictures comprising Q columns of tiles, N being an integer exceeding 1, N being an integer exceeding 1, P, Q being positive integers, partitioning the Q columns of tiles into S sub-slices, the S sub-slices containing k sets of Q sub-slices, each set of Q sub-slices being partitioned in the Q columns, the S sub-slices being non-overlapping with each other, S being an integer exceeding 1, k being a positive integer, and a processor decoding each set of Q sub-slices from a sub-slice in a first column of tiles to a sub-slice in a Qth column of tiles sequentially.

According to another embodiment of the invention, a method of decoding a picture frame from a bitstream includes grouping N tiles of the picture frame into P sub-pictures, the P sub-pictures being non-overlapping with each other, a sub-picture of the P sub-pictures comprising I tiles distributed in Q columns of tiles, N being an integer exceeding 1, I, P, Q being positive integers, partitioning the I tiles into S sub-slices, the I tiles containing J1 sub-slices on an a-th row of the I tiles and J2 sub-slices on an (a+h)-th row of the I tiles, the S sub-slices being non-overlapping with each other, h, S being positive integers exceeding 1, a, J1, J2 being positive integers, and a processor decoding the J1 sub-slices before the J2 sub-slices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is schematic diagram of the decoding order in a picture.

FIG. 2A shows AV1 video format.

FIG. 2B shows HEVC video format.

FIG. 3 is a schematic diagram of a picture divided into sub-pictures and sub-slices.

FIG. 4 is a flowchart of a low-latency video decoder process.

FIG. 5 and FIG. 6 are block diagrams of low latency video decoder systems.

FIG. 7 is a schematic diagram of a low latency decoding order for a single processor.

FIG. 8 is a schematic diagram of another low latency decoding order for a single processor.

FIG. 9 is a flowchart of a method of decoding the picture frames in FIGS. 16 and 17 from the bitstream.

FIG. 10 is a schematic diagram of another low latency decoding order for a single processor.

FIG. 11 is a schematic diagram of another low latency decoding order for dual processors.

FIG. 12 is a schematic diagram of another low latency decoding order for dual processors.

FIG. 13 is a flowchart of a method of decoding the picture frames from the bitstream.

FIG. 14 is a schematic diagram of another low latency decoding order for multiple processors.

FIG. 15 is a schematic diagram of another low latency decoding order for multiple processors.

FIG. 16 is a schematic diagram of another low latency decoding order for multiple processors.

FIG. 17 is a schematic diagram of another low latency decoding order for multiple processors.

FIG. 18 is a schematic diagram of another low latency decoding order for multiple processors.

FIG. 19 is a schematic diagram of another low latency decoding order for multiple processors.

FIG. 20 is a flowchart of a method of decoding the picture frames from the bitstream.

FIG. 21 is a schematic diagram of the reconstruct buffer and the display driver adopting the normal decoding order at t=t0+46*tctu.

FIG. 22 is a schematic diagram of the reconstruct buffer and the display driver adopting the normal decoding order at t=t0+59*tctu.

FIG. 23 is a schematic diagram of a reconstruct buffer and a display driver adopting the low latency decoding order at t=t0+13*tctu.

FIG. 24 is a schematic diagram of the reconstruct buffer and the display driver adopting the normal decoding order at t=t0+26*tctu.

FIG. 25 is a schematic diagram of the reconstruct buffer and the display driver adopting the normal decoding order at t=t0+90*tctu.

FIG. 26 is a schematic diagram of the reconstruct buffer and the display driver adopting the normal decoding order at t=t0+103*tctu.

FIG. 27 is a schematic diagram of a reconstruct buffer and a display driver adopting the low latency decoding order at t=t0+13*tctu.

FIG. 28 is a schematic diagram of the reconstruct buffer and the display driver adopting the normal decoding order at t=t0+26*tctu.

### DETAILED DESCRIPTION

The embodiments of the invention are applicable to video decoders or video coder/decoders (codecs) supporting a tile-based video coding standard, such as high efficiency video coding (HEVC), versatile video coding (VVC), video processor 9 (VP9), alliance for open media video 1 (AV1), and audio video coding standard 3 (AVS3). In general, a picture is partitioned into one or more tiles, where each tile contains one or more largest coding units (LCUs). For H.264, HEVC, VVC, and AVS3, the LCUs may be referred to as coding tree units (CTUs). For VP9 and AV1, the LCUs may be referred to as super block (SB). The size of each LCU (CTU/SB) is at least 16×16 pixels. As used in various embodiments of the invention, the tiles are defined by bold lines, and the LCUs (CTUs/SBs) are defined by thin lines. The tiles have no dependencies on each other and can serve as the smallest unit for parallel decoding or multi-processor decoding. The decoding order of the video decoders/video codecs is tile-based and LCU-based, from left to right and from top to bottom, referred to as the tile-based raster order decoding. In a picture, the tiles are decoded in the tile-based raster order, the tiles being identical or different in shapes, and in each tile, the LCUs are decoded in a LCU-based raster order.

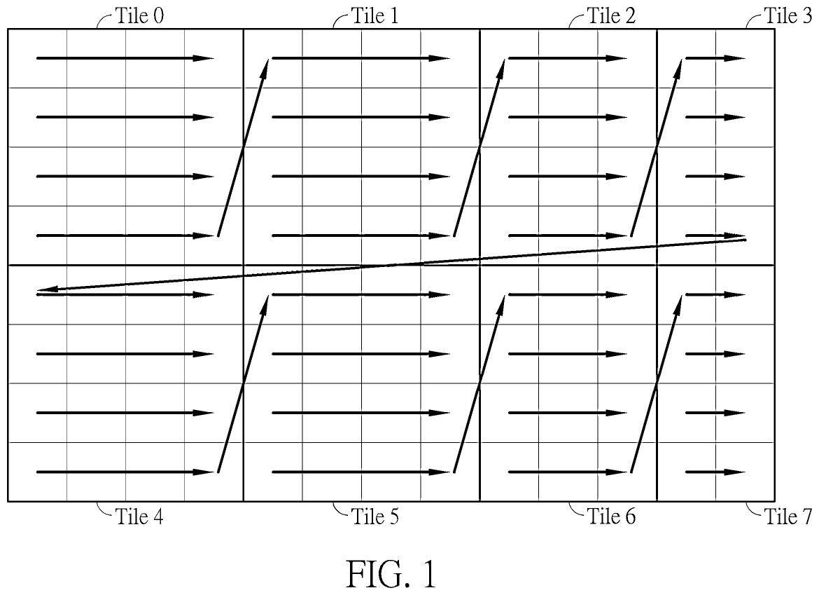

In an embodiment in FIG. 1, a picture is partitioned into Tiles 0 to 7 arranged in 2 rows of tiles (referred to as tile rows) and 4 columns of tiles (referred to as tile columns), with Tile 0 including 4×4 LCUs, Tile 1 including 4×4 LCUs, Tile 2 including 3×4 LCUs, Tile 3 including 2×4 LCUs, Tile 4 including 4×4 LCUs, Tile 5 including 4×4 LCUs, Tile 6 including 3×4 LCUs, and Tile 7 including 2×4 LCUs. In FIG. 1, the picture is decoded from Tiles 0 to 7 in the tile-based raster order, and the LCUs in each of Tile 0 to 7 are decoded from left to right and from top to bottom in the LCU-based raster order. For example, Tiles 0 to 7 are decoded sequentially from the top tile row to the bottom tile row following the arrow direction, and the 4×4 LCUs of Tile 0 are decoded sequentially from the top LCU rows to the bottom LCU rows following the arrow direction. The decoded bitstream is outputted in the pixel-based raster order regardless of the decoding order. A delay or a glitch in the decoded bitstream may result in image defects. Therefore, the display starts only after the reconstruct buffer holds more than one row of decoded pixels.

In the embodiments of the present invention, a picture frame is decoded from a bitstream, the picture frame including N tiles, N being an integer exceeding 1. For example, if N=8, the picture frame includes 8 tiles. The picture may be partitioned by vertical tile boundaries (e.g., 3 vertical tile boundaries) to arrive one or more tile columns (e.g., 4 tile columns), and may be partitioned by horizontal tile boundaries (e.g., 1 horizontal tile boundary) to arrive one or more tile rows (e.g., 2 tile rows). When the number of tile columns in a video frame exceeds the number of available cores (or processors) in the video decoder is less than the number of tile columns, the decoding order may be adjusted to ensure efficient utilization of the hardware resources and minimize display latency. The display latency refers to the time elapsed between the video decoder receiving the bitstream and the display panel displaying of the decoded bitstream. To address the issue, sub-pictures and/or sub-slices are introduced. In general, the sub-pictures may be decoded in parallel by multiple processors of the video decoder, accelerating the decoding process, and the decoding order of the sub-slices in each sub-picture may be aligned with the display order, ensuring that the decoded data is available for display as soon as possible, thereby reducing the display latency.

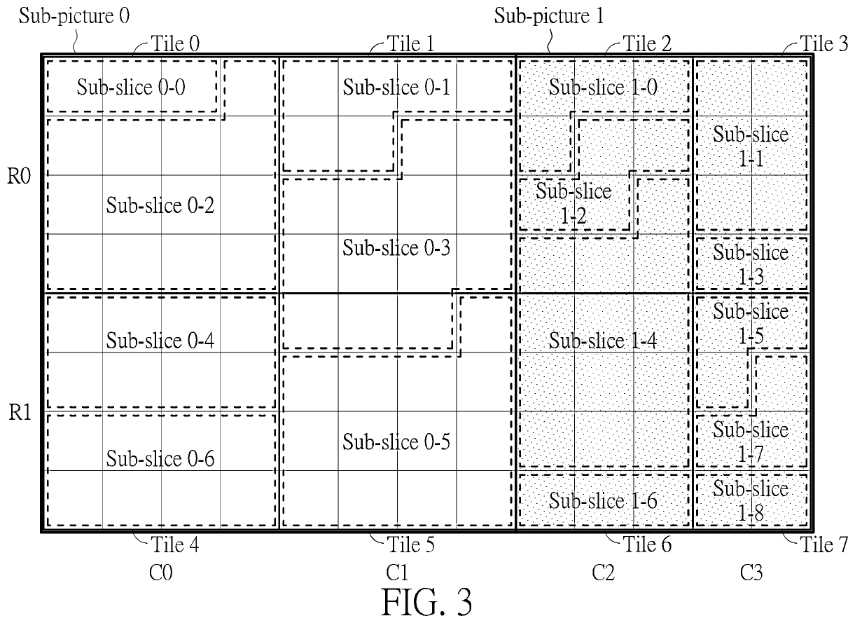

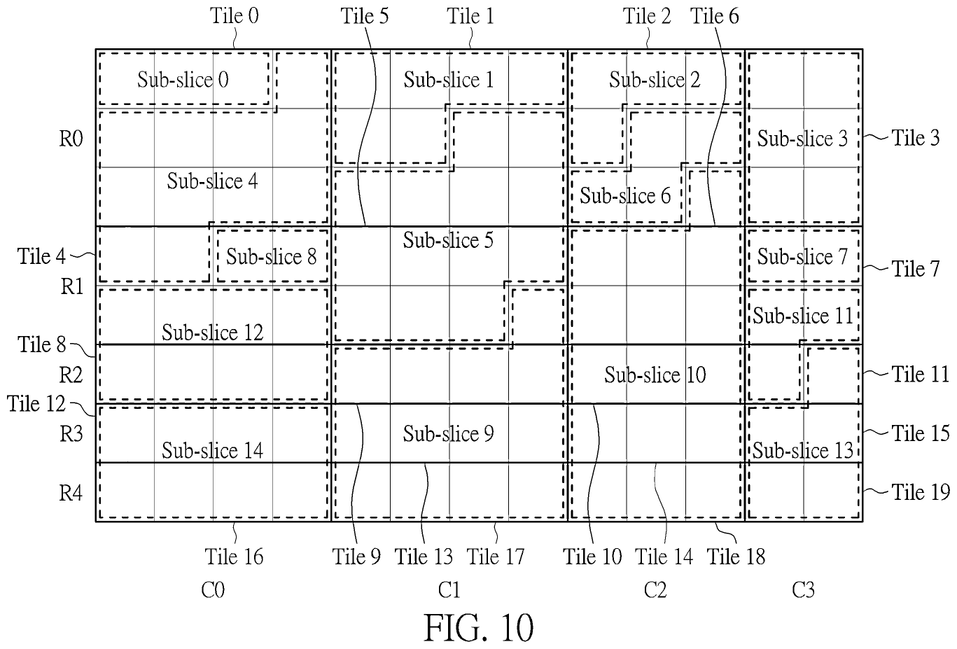

In an embodiment of the present invention, the concepts of the sub-pictures and the sub-slices are introduced, and the definitions of the sub-picture and the sub-slice are provided as follows:
1. A sub-picture is a partition of a picture for multi-processor decoding. A picture may be partitioned into at least one sub-pictures, a sub-picture may include at least one tiles, and there is no overlapping LCUs or tiles between the sub-pictures. Further, the tiles in the sub-picture may be arranged in a rectangular or non-rectangular shape. The tiles in the sub-picture are decoded in tile-based raster order, and the LCUs in the tiles are internally decoded in the LCU-based raster order. In a multi-processor device, each sub-picture may be assigned to a processor, and each processor may decode one or more assigned sub-pictures. For example, if a picture includes 2 sub-pictures and a video decoder includes 2 processors, one of the 2 sub-pictures may be assigned to a first processor for decoding, and the other one of the 2 sub-pictures may be assigned to a second processor for decoding. In another example, if a picture includes 3 sub-pictures and the video decoder includes the 2 processors, 2 of the 3 sub-pictures may be assigned to the first processor for decoding, and the remaining one of the 3 sub-pictures may be assigned to the second processor for decoding. The first processor and the second processor may operate simultaneously to speed up decoding, being beneficial for reducing display latency.
2. A sub-slice is a partition of the sub-picture for providing a breakpoint for decoding, thereby adjusting the decoding order. Each tile column of the sub-picture may be partitioned into sub-slices, the sub-slices being non-overlapping with each other. The sub-slice may include one or more continuous LCUs, and the LCUs in the sub-slice may be arranged in a rectangular or non-rectangular shape. Each sub-slice may be labeled with a sequence number for decoding. For example, a sub-slice having a sequence number of 0 may be decoded first, followed by another sub-slice having a sequence number of 1, followed by another sub-slice having a sequence number of 2, and so on. In some embodiments, two sub-slices in two adjacent tile columns may be labeled with continuous sequence numbers. In other embodiments, two sub-slices in one tile column may be labeled with discontinuous sequence numbers. In other embodiments, two sub-slices in one tile column may be labeled with continuous sequence numbers. A sub-slice may occupy one or more tiles in the same tile column but not two or more tiles in the same or different tile rows of the sub-picture. In some embodiments, a sub-slice may occupy parts of two tiles in the same tile column. For example, for single processor decoding as shown in FIG. 10, Sub-slice 3 occupies the entire Tile 3 in the tile column C3, Sub-slice 5 occupies parts of Tile 1 and Tile 5 in the tile column C1, and Sub-slice 9 occupies part of Tile 5, and the entire Tile 9, Tile 13 and Tile 17 in the tile column C1. Likewise, for dual processor decoding as shown in FIG. 3, Sub-slice 0-3 occupies parts of Tile 1 and Tile 5 in the tile column C1, Further, a tile may contain one or multiple sub-slices. For example, for single processor decoding in FIG. 10, Tile 3 contains the entire Sub-slice 3, and Tile 2 contains the entire Sub-slice 2 and Sub-slice 6, and a part of Sub-slice 10. Similarly, for dual processor decoding in FIG. 3, Tile 0 contains the entire Sub-slice 0-0 and Sub-slice 0-2.

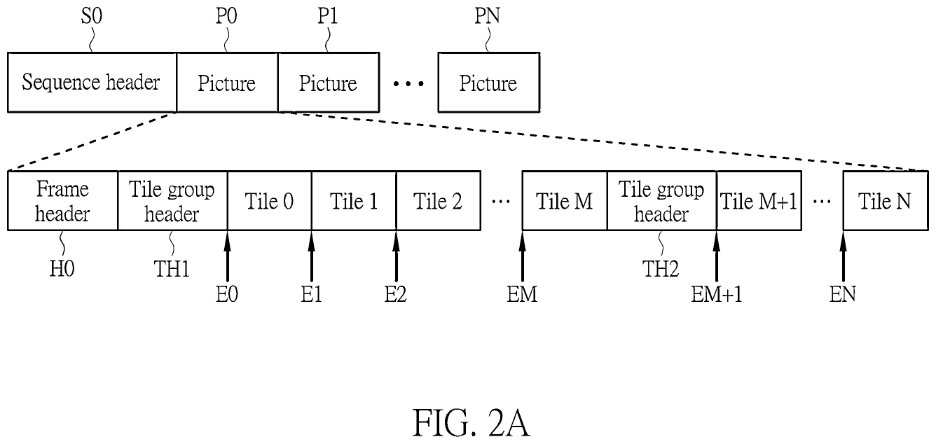

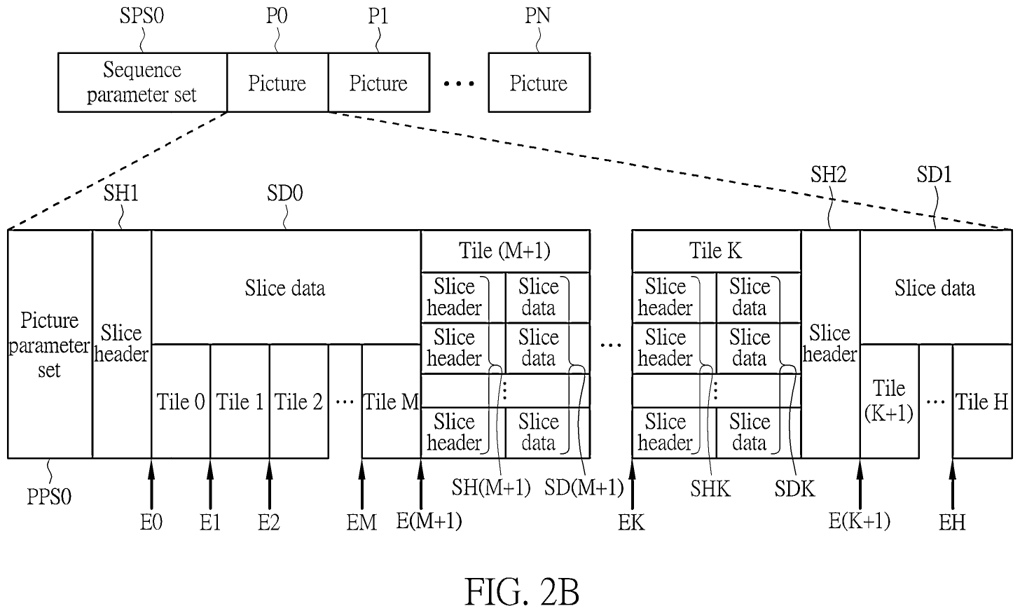

FIG. 2A and FIG. 2B show AV1 video format and HEVC video format, respectively. The independent encoding/decoding properties of each tile, which can be used to adjust the encoding/decoding sequence, are explained with reference to FIG. 2A and FIG. 2B as follows:
1. The video decoder may decode each tile independently, and thus, the starting point (or referred to as the entry point, e.g., E0 to EN in FIG. 2A, and E0 to EH in FIG. 2B) in the bitstream is identified for each tile, as shown by the arrows in FIG. 2A and FIG. 2B. In FIG. 2A, a bitstream includes a sequence header S0 and Picture P0 to Picture PN. Picture P0 includes a frame header H0, a first tile group header TH1, Tiles 0 to M corresponding to the first tile group header TH1, a second group header TH2, Tiles (M+1) to N corresponding to the second group header TH2, and other groups of tiles. The frame header H0 may contain information related to the number of the columns of tiles (e.g., num_tile_columns_minus1) and the number of the rows of tiles (e.g., num_tile_rows_minus1) in Picture P0. In FIG. 2B, a bitstream includes a sequence parameter set SPS0 and Picture P0 to Picture PN. Picture P0 includes a picture parameter set PPS0, a slice header SH1, Tiles 0 to M of slice data SD0, Tile M+1 to Tile K, a slice header SH2, Tiles (K+1) to H of slice data SD1. A piece of the slice data may occupy a plurality of tiles. For example, the slice data SD0 occupies Tile 0 to Tile M and the slice data SD1 occupies Tile (K+1) to Tile N. Further, a tile may include a plurality of slice segments. For example, Tile (M+1) may include multiple sets of Slice headers SH(M+1) and Slice data SD(M+1), and Tile K may include multiple sets of Slice headers SHK and Slice data SDK, each set of Slice header and Slice data corresponding to a slice segment. The video decoder may identify the number of tiles in each picture according to the information related to the number of the columns of tiles and the number of the rows of tiles, and determine the entry points of the tiles (E0 to EN) in each picture accordingly. In some embodiments, the video encoder/decoder may determine (num_tile_columns_minus1+1)*(num_tile_rows_minus1+1) as the number of tiles in the picture, and determine the entry points of the tiles in the picture according to the number of tiles in the picture. For example, if num_tile_columns_minus1=3 and num_tile_rows_minus1=1, the number of tiles=8 (=(3+1)*(1+1)). The video encoder/decoder may determine 8 entry points of the tiles accordingly.
2. The video decoder may include a plurality of processors, and may partition a picture into a number of sub-pictures equal to the number of processors, as shown in FIG. 3. For example, if the video decoder includes 2 processors, the video decoder may partition the picture into Sub-picture 0 and Sub-picture 1.
3. Partition a tile column into at least one sub-slices according to the delay requirements. The picture in FIG. 3 is partitioned into Tiles 0 to 7 arranged in 2 tile rows (R0 and R1) and 4 tile columns (C0 to C3). Regarding the size of the sub-slice, the height of the sub-slice may be set for short delay requirement. For example, 1 CTU/SB in height of the sub-slice may be set for the shortest delay requirement. To simplify the control settings, the sub-slice may be set to a rectangle, and the width of the sub-slice may be set to the width of the tile. The decoding order may be determined according to the requirements. After decoding 0 or more sub-slices in the same tile column, the video decoder may switch to another tile column to decode 0 or more sub-slices until all sub-slices in the sub-pictures are decoded. The sub-slices are decoded internally in CTU/SB raster order. As shown in FIG. 3, for Sub-picture 0 on the left side, the decoding order may be Sub-slice 0-0, Sub-slice 0-1, Sub-slice 0-2, Sub-slice 0-3, Sub-slice 0-4, Sub-slice 0-5, and Sub-slice 0-6. For Sub-picture 1 on the right side, the decoding order may be Sub-slice 1-0, Sub-slice 1-1, Sub-slice 1-2, Sub-slice 1-3, Sub-slice 1-4, Sub-slice 1-5, Sub-slice 1-6, Sub-slice 1-7, and Sub-slice 1-8.
4. To ensure decoding accuracy, after the last CTU/SB in the sub-slice is decoded, the currently decoded tile information needs to be saved. The tile information includes arithmetic decoding information, context required for arithmetic decoding, bitstream consumption, and other information. In some embodiments, other information may include an offset and a range for arithmetic decoding. If the current CTU/SB is the last CTU/SB of a tile (e.g., the 16^{th} CTU of Tile 0), as shown in FIG. 3, it is optional to retain the tile information of the current CTU/SB because the tiles are decoded independently of each other, and the tile information of the current CTU/SB will no longer be used in the decoding of the next tile (e.g., the tile information of Tile 0 will not be used for decoding Tile 1).
5. Before decoding the first CTU/SB of the sub-slice, the retained tile information is read to enable continuous decoding, as shown in FIG. 3. If the current CTU/SB is the first CTU/SB of the tile (e.g. the 1^{st} CTU of Tile 4 in FIG. 3), it is optional to read the tile information (e.g., optional to read the tile information of Tile 0 before decoding Tile 4) because the tiles are decoded independently of each other, thus the tile information will not be used.
6. The memory space of the video decoder required to store the tile information is (the number of tile columns) * (the space of tile information). For example, if the number of tile columns=4 and the space of tile information is 1 byte, the memory space required is 4 bytes.

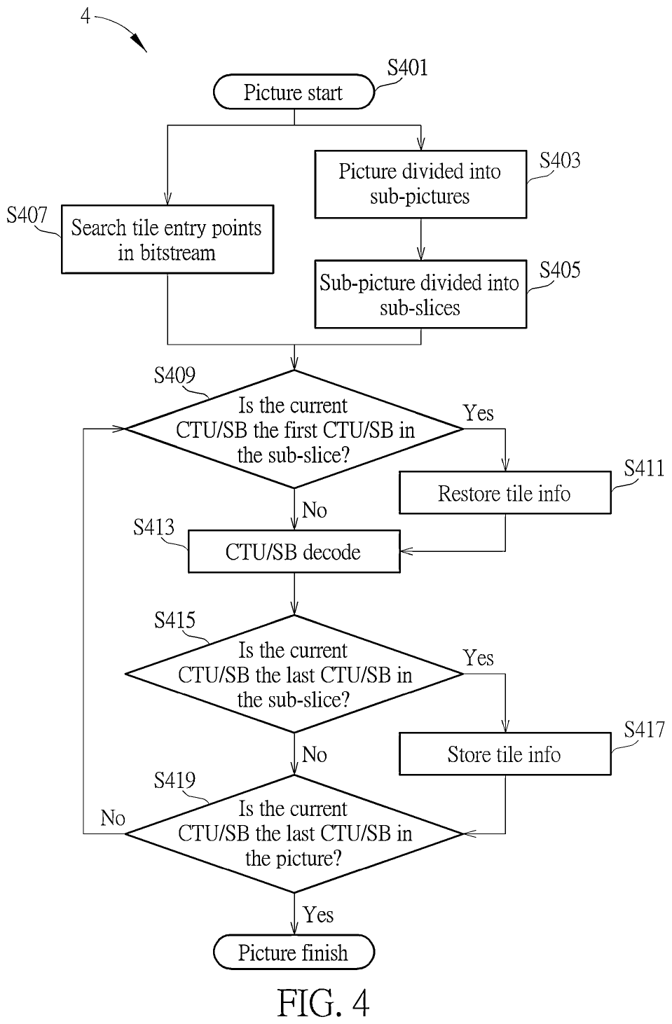

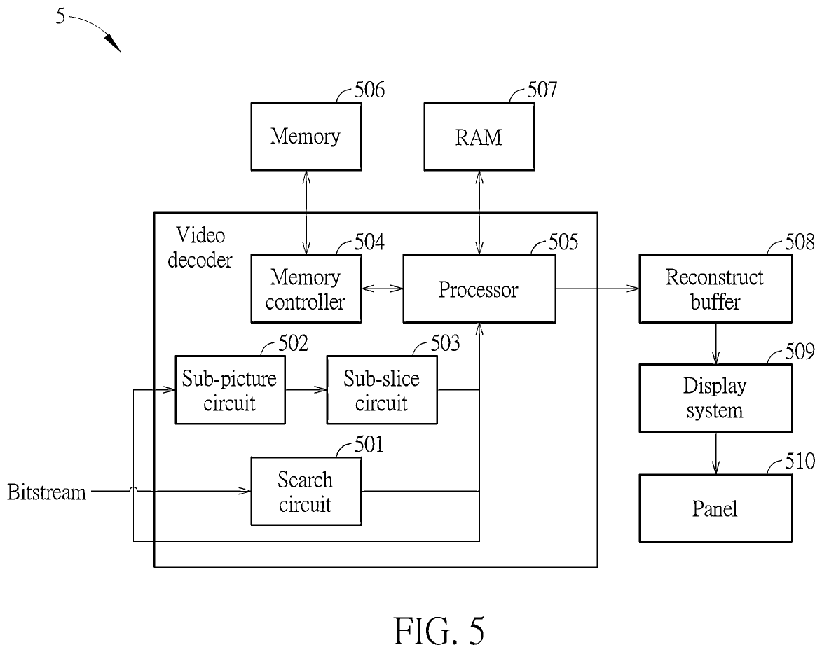

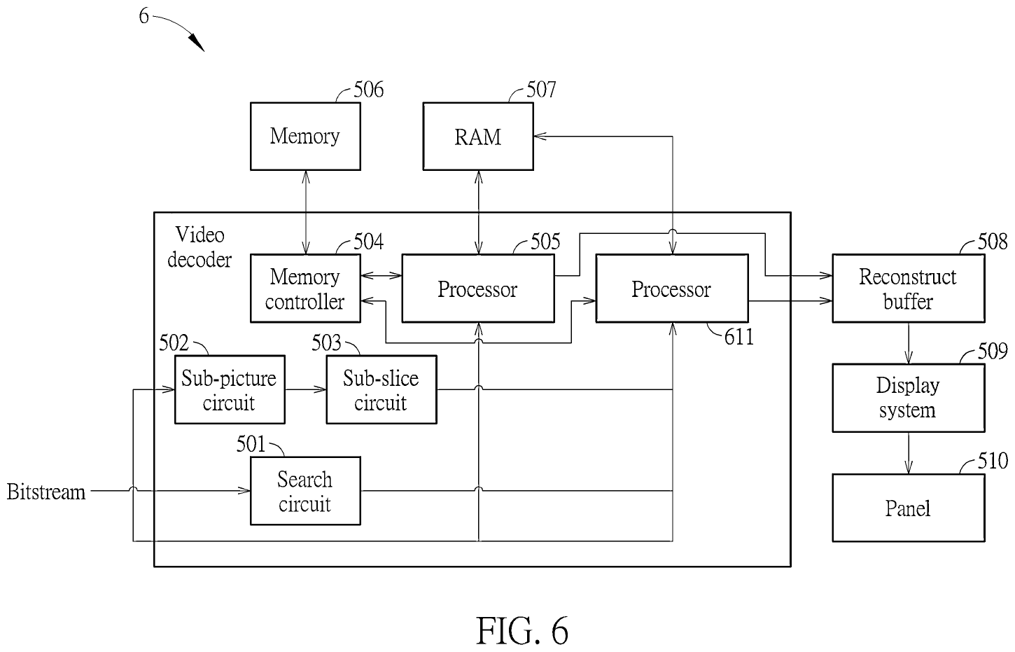

FIG. 4 is a flowchart of a low-latency video decoder process 4 according to an embodiment of the disclosure. FIG. 5 is a block diagram of a low latency video decoder system 5, and FIG. 6 is a block diagram of another low latency video decoder system 6. FIG. 5 shows a single-processor video decoder and FIG. 6 shows a multi-processor video decoder respectively. The video decoders in FIGS. 5 and 6 may adopt the low-latency video decoder process 4 in FIG. 4 to achieve low latency decoding.

The method 4 includes Steps S401 to S419. Any reasonable step change or adjustment is within the scope of the disclosure. Steps S401 to S419 are detailed as follows:
Step S401: Picture start;
Step S403: Picture divided into sub-pictures;
Step S405: Sub-picture divided into sub-slices;
Step S407: Search tile entry points in bitstream;
Step S409: Is the current CTU/SB the first CTU/SB in the sub-slice? If so, go to Step S411; if not, go to Step S413;
Step S411: Restore tile info;
Step S413: CTU/SB decode;
Step S415: Is the current CTU/SB the last CTU/SB in the sub-slice? If so, go to Step S417; if not, go to Step S419;
Step S417: Store tile info;
Step S419: Is the current CTU/SB the last CTU/SB in the picture? If so, picture finish; if not, go to Step S409.

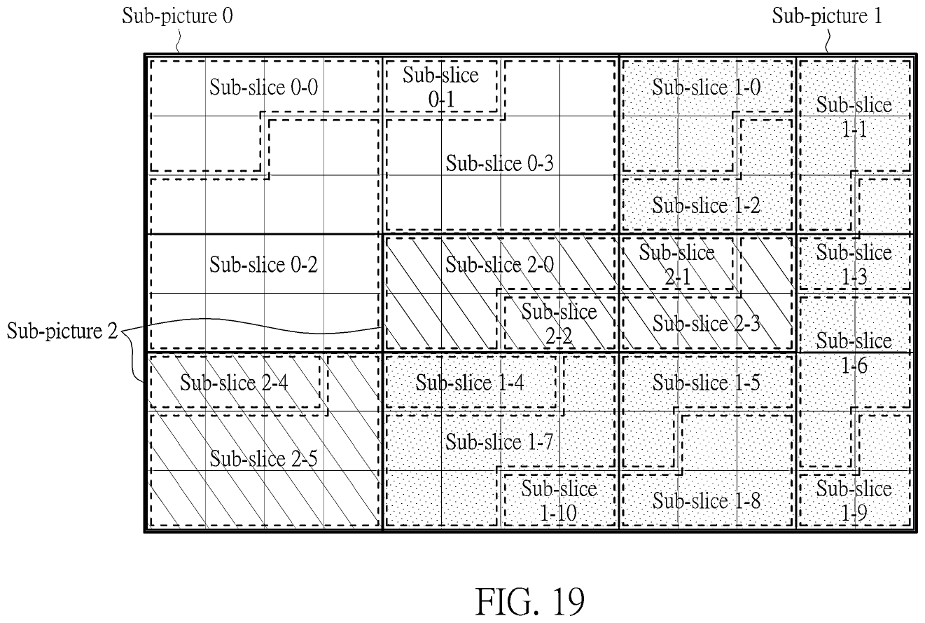

The low-latency video decoder process 4 in FIG. 4 is now explained with reference to the video decoder in FIG. 5. As shown in FIG. 5, the video decoder is used to decode a picture frame from a bitstream, and may include a search circuit 501, a sub-picture circuit 502, a sub-slice circuit 503, a memory controller 504, and a processor 505. In Step S403, the sub-picture circuit 502 groups N tiles into P sub-pictures, the P sub-pictures being non-overlapping with each other, a first sub-picture of the P sub-pictures comprising Q columns of tiles, a second sub-picture of the P sub-pictures may comprise R columns of tiles, N being an integer exceeding 1, P, Q, R being positive integers. For example, if N=8, P=2, and Q=2, the sub-picture circuit groups 8 tiles into 2 non-overlapping sub-pictures, each sub-picture being decoded by a separate processor, the first sub-picture of the 2 sub-pictures including 2 tile columns and 2 tile rows, and the second sub-picture of the 2 sub-pictures including 2 tile columns and 2 tile rows. Depending on the shapes of the P sub-pictures, the numbers of tile columns of 2 sub-pictures in the P sub-pictures may be equal or different, and the numbers of tile rows of 2 sub-pictures in the P sub-pictures may be equal or different. In some embodiments, each of the P sub-pictures comprises tiles arranged in a rectangle, as shown in FIG. 3. In other embodiments, a sub-picture of the P sub-pictures comprises tiles arranged in a non-rectangular shape, as shown in FIG. 19, and will be discussed in detail later. In some embodiments, the dimensions of 2 sub-pictures in the P sub-pictures may be identical (e.g., Sub-picture 0 contains 8×8 CTUs arranged in a rectangle, and Sub-picture 1 contains 8×8 CTUs arranged in a rectangle). In other embodiments, the dimensions of 2 sub-pictures in the P sub-pictures may be different (e.g., Sub-picture 0 contains 8×8 CTUs arranged in a rectangle, and Sub-picture 1 contains 5×8 CTUs arranged in a rectangle).

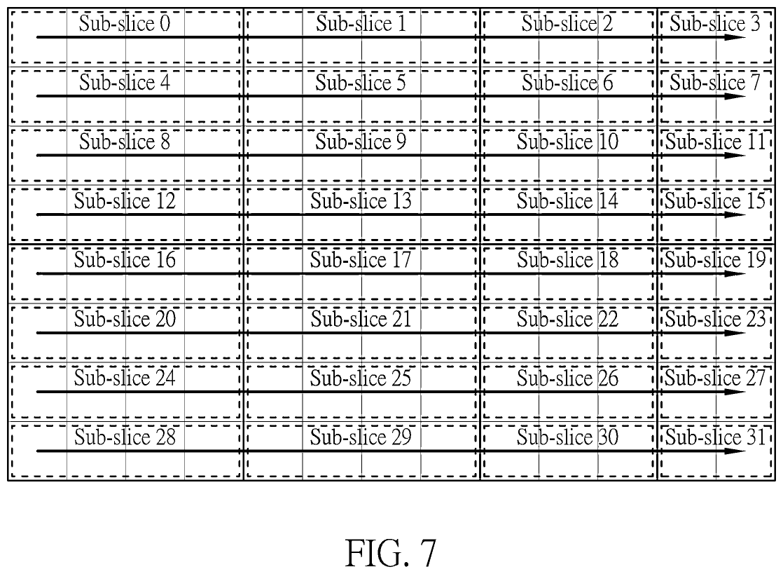

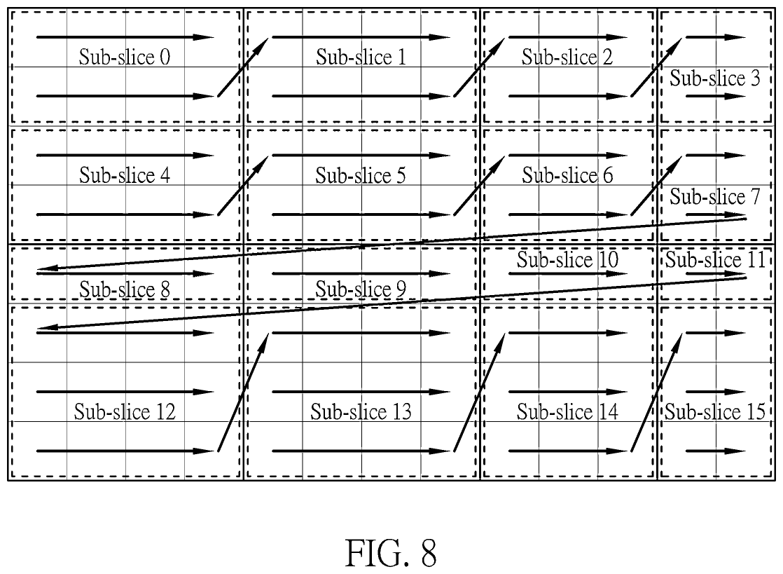

The sub-slice circuit 503 is coupled to the sub-picture circuit 502 to partition a first column of tiles of the Q columns of tiles into M sub-slices in Step S405, the M sub-slices being non-overlapping with each other, M being an integer exceeding 1. For example, if M=8, the sub-slice circuit 503 partitions the first tile column into 8 non-overlapping sub-slices. Similarly, the sub-slice circuit 503 may further partition a second tile column of the first sub-picture into 8 or a different number of non-overlapping sub-slices in Step S405. In some embodiments, each of the M sub-slices comprises CTUs arranged in a rectangle, as shown in FIGS. 7 and 8, and will be discussed in detail later. In some embodiments, the rectangle may have a height equal to a height of an LCU, and may have a width equal to the width of a column of tiles, resulting in matching decoding order and display order, thereby reducing display latency. In other embodiments, a sub-slice of the M sub-slices comprises CTUs arranged in a non-rectangular shape, as shown in FIG. 10, and will be discussed in detail later. In some embodiments, the dimensions of 2 sub-slices in the M sub-slices may be identical (e.g., each of the M sub-slices contains 4×1 CTUs arranged in a rectangle in FIG. 8). In other embodiments, the dimensions of 2 sub-slices in the M sub-slices may be different (e.g., the dimensions of Sub-slice 0 and Sub-slice 4 in FIG. 10 are different).

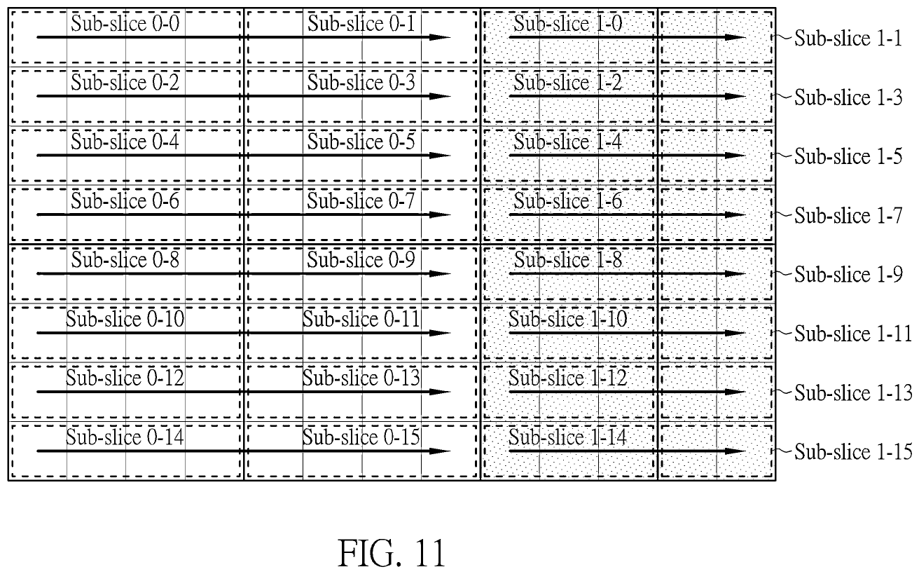

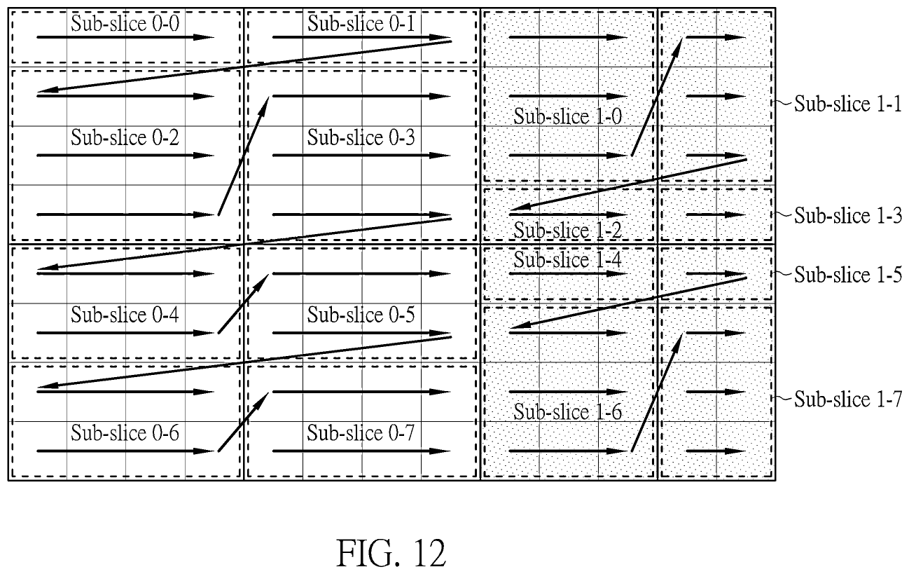

The sub-slice circuit 503 may further partition a first column of tiles of the R columns of tiles into O sub-slices in Step S405, the O sub-slices being non-overlapping with each other, O being an integer exceeding 1. For example, if O=8, the sub-slice circuit 503 partitions the first tile column into 8 non-overlapping sub-slices. Similarly, the sub-slice circuit 503 may further partition a second tile column of the second sub-picture into 8 or a different number of non-overlapping sub-slices in Step S405. In some embodiments, each of the O sub-slices comprises CTUs arranged in a rectangle, as shown in FIGS. 11 and 12, and will be discussed in detail later. In other embodiments, a sub-slice of the O sub-slices comprises CTUs arranged in a non-rectangular shape, as shown in FIG. 3, and will be discussed in detail later. In some embodiments, the dimensions of 2 sub-slices in the O sub-slices may be identical (e.g., each of the O sub-slices contains 3×1 CTUs arranged in a rectangle in FIG. 11). In other embodiments, the dimensions of 2 sub-slices in the O sub-slices may be different (e.g., Sub-slice 1-0 contains 3×1 CTUs arranged in a rectangle and Sub-slice 1-1 contains 2×1 CTUs arranged in a rectangle in FIG. 11).

In Step S407, the search circuit 501 searches N tile entry points of the N tiles from the bitstream, and outputs the N tile entry points to the processor 505, each of the N tiles comprising a plurality of largest coding units. For example, if N=8, the search circuit 501 searches 8 tile entry points of the 8 tiles from the bitstream.

In Step S411, the memory controller 504 is coupled to a memory 506 to obtain the first tile information from the memory prior to decoding a current sub-slice of the M sub-slices in the first sub-picture. The first tile information may include a first context, a first offset, a first range for arithmetic decoding and a first quantity of decoded bits upon completion of decoding a previous sub-slice of the M sub-slices. For example, in HEVC standard, the first context may be from ctxTable, the first range may be the ivlRange parameter, and the first offset may be the ivlOffset parameter. During decoding, the bitstream may be decoded according to the first context to generate a bit value, the bit value falling within the first range. The bit value is compared against the first offset to generate a decoded bit. For example, the decoded bit may be 1 if the bit value is greater than the first offset, and the decoded bit may be 0 if the bit value is less than the first offset. The memory 506 may be internal or external to the video decoder 5. The processor 505 (which is the first processor) may receive the bitstream, and is coupled to the sub-slice circuit 503 and the search circuit 501 to receive the M sub-slices and the N tile entry points. The processor 505 may be coupled to a random access memory (RAM) 507 to buffer data. Further, in Step S413, the processor 505 is coupled to the memory controller 504 to decode the current sub-slice of the M sub-slices according to the first tile information, so as to generate a decoded bitstream. In Step S417, the memory controller 504 further stores second tile information in the memory upon completion of decoding the current sub-slice of the M sub-slices. The second tile information may include a second context, a second offset, and a second range for arithmetic decoding and a second quantity of decoded bits upon the completion of decoding the current sub-slice of the M sub-slices. The explanation of the second context, the second offset, and the second range are similar to the first context, the first offset, and the first range, and will be repeated here for brevity. In Step S419, if it is not yet the last CTU/SB of the sub-picture, the processor 505 of the video decoder continues the loop (S409 to S419) until the last CTU/SB of the sub-picture is decoded. The reconstruct buffer 508 is coupled to the processor 505 to buffer the decoded bitstream and send the decoded bitstream to the display system 509 for display on the display panel 510.

Similarly, the memory controller 504 may obtain third tile information from the memory prior to decoding a current sub-slice of the O sub-slices in the second sub-picture. The third tile information may include a third context, a third offset, a third range for arithmetic decoding and a third quantity of decoded bits upon completion of decoding a previous sub-slice of the O sub-slices. The explanation of the third context, the third offset, and the third range are similar to the first context, the first offset, and the first range, and will be repeated here for brevity. FIG. 6 is a block diagram of another low latency video decoder system 6. The difference between the low latency video decoder system 6 and the low latency video decoder system 5 is the low latency video decoder system 6 includes another processor 611 (which is the second processor). The rest of the low latency video decoder system 5 and the low latency video decoder system 6 are the same and will not be repeated here. As shown in FIG. 6, the processor 611 may receive the bitstream, and may be coupled to the sub-slice circuit 503 and the search circuit 501 to receive the O sub-slices and the N tile entry points. Further, the processor 611 may be coupled to the memory controller 504 to decode the current sub-slice of the O sub-slices according to the third tile information, so as to generate a decoded bitstream. The memory controller 504 further stores fourth tile information in the memory 506 upon completion of decoding the current sub-slice of the O sub-slices. The fourth tile information may include a fourth context, a fourth offset, a fourth range for arithmetic decoding, and a fourth quantity of decoded bits upon the completion of decoding the current sub-slice of the O sub-slices. The explanation of the fourth context, the fourth offset, and the fourth range are similar to the first context, the first offset, and the first range, and will be repeated here for brevity. In Step S419, if it is not yet the last CTU/SB of the sub-picture, the processor 611 of the video decoder continues the loop (S409 to S419) until the last CTU/SB of the sub-picture is decoded. The reconstruct buffer 508 is coupled to the processor 505 to buffer the decoded bitstream and send the decoded bitstream to the display system 509 for display on the display panel 510.

Please refer to FIG. 1, FIG. 1 is an embodiment of video decoding for tile column=4, tile row=2. The original image decoding order is represented by the arrows in FIG. 1. The thick lines delineate the boundaries of tiles, and the thin lines delineate the boundaries of CTU/SB. The decoding order follows the arrow direction, that is, the picture is decoded in the tile raster order, and each tile is decoded in the CTU/SB raster order.

FIG. 7 is a schematic diagram of a low latency (CTU/SB raster order) decoding order for picture with tile column=4, tile row=2, sub-slice width=tile width, sub-slice height=1, with the video decoder only including 1 processor. The dashed lines represent boundaries of the sub-slices (32 sub-slices in total). The widths of the sub-slices from left to right (e.g., Sub-slices 0 to 3) are 4 CTU/SB, 4 CTU/SB, 3 CTU/SB, 2 CTU/SB, respectively, and the heights of the sub-slices from left to right (e.g., Sub-slices 0 to 3) are 1 CTU/SB. The sub-slices may be decoded in CTU/SB raster order as indicated by the arrow direction. Thus, the decoding order matches the display order, resulting in a reduction in the display latency and the size of the reconstruct buffer. FIG. 7 is provided as an example, and should not be interpreted as limiting the configurations of the tile rows, the tile columns, and the sub-slices.

FIG. 8 is a schematic diagram of another low latency decoding order for picture with tile column=4, tile row=2, various size rectangular sub-slices, with the video decoder only has 1 processor. Sub-slices 0 to 15 contain 4×2 CTUs/SBs, 4×2 CTUs/SBs, 3×2 CTUs/SBs, 2×2 CTUs/SBs, 4×2 CTUs/SBs, 4×2 CTUs/SBs, 3×2 CTUs/SBs, 2×2 CTUs/SBs, 4×1 CTUs/SBs, 4×1 CTUs/SBs, 3×1 CTUs/SBs, 2×1 CTUs/SBs, 4×3 CTUs/SBs, 4×3 CTUs/SBs, 3×3 CTUs/SBs, and 3×2 CTUs/SBs, respectively. Every sub-slice is rectangular. The decoding order follows the arrow direction, and roughly matches the display order, reducing the display latency and the size of the reconstruct buffer. FIG. 8 is provided as an example, and should not be interpreted as limiting the configurations of the tile rows, the tile columns, and the sub-slices.

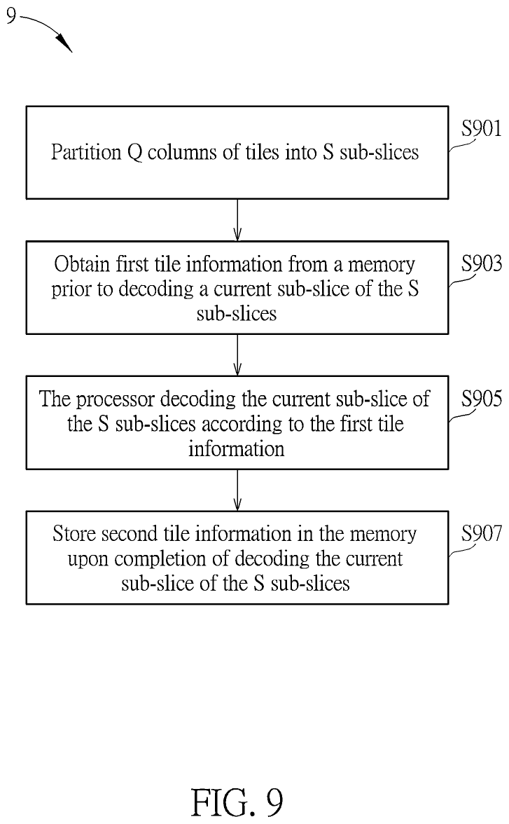

FIG. 9 is a flowchart of a method 9 of decoding the picture frames. The video decoder may utilize a method 9 of decoding the picture frames in FIGS. 7 and 8 from the bitstream. The method 9 includes Steps S901 to S907. Any reasonable step change or adjustment is within the scope of the disclosure. Steps S901 to S907 are detailed as follows:
Step S901: Partition Q columns of tiles into S sub-slices, the S sub-slices containing k sets of Q sub-slices, each set of Q sub-slices being partitioned from a first column to a Qth column, the S sub-slices being non-overlapping with each other, Q, k being positive integers, S being an integer exceeding 1;
Step S903: Obtain first tile information from a memory prior to decoding a current sub-slice of the S sub-slices;
Step S905: The processor decoding the current sub-slice of the S sub-slices according to the first tile information;
Step S907: Store second tile information in the memory upon completion of decoding the current sub-slice of the S sub-slices.

The method 9 is now explained with reference to the picture frame in FIG. 7. In FIG. 7, Q=4, S=32, k=8. The method 9 may be adopted by a single-processor video decoder, and may be used to define sub-slices without defining a sub-picture in the picture. The video decoder partitions 4 tile columns into 32 sub-slices (Step S901). The 32 sub-slices are non-overlapping with each other and may include 8 sets of 4 sub-slices. The video decoder may decode each set of 4-sub-slices from a sub-slice in a first tile column to a sub-slice in a 4th tile column sequentially. The first set of 4 sub-slices sequentially includes Sub-slices 0 to 3. The second set of 4 sub-slices sequentially includes Sub-slices 4 to 7, the third set of 4 sub-slices sequentially includes Sub-slices 8 to 11, the fourth set of 4 sub-slices sequentially includes Sub-slices 12 to 15, the fifth set of 4 sub-slices sequentially includes Sub-slices 16 to 19, the sixth set of 4 sub-slices sequentially includes Sub-slices 20 to 23, the seventh set of 4 sub-slices sequentially includes Sub-slices 24 to 27, and the eighth set of 4 sub-slices sequentially includes Sub-slices 28 to 31. The video decoder may decode the first set of 4 sub-slices sequentially from Sub-slice 0 in the first tile column to Sub-slice 3 in the 4th tile column. The decoding order of the second to the eighth sets of 4 sub-slices may be similar to the first set of 4 sub-slices.

The method 9 is now explained with reference to the picture frame in FIG. 8. In FIG. 8, Q=4, S=16, k=4. The method 9 may be adopted by a single-processor video decoder, and may be used to define sub-slices without defining a sub-picture in the picture. The video decoder partitions 4 tile columns into 16 sub-slices (Step S901). The 16 sub-slices are non-overlapping with each other and may include 4 sets of 4 sub-slices. The video decoder may decode each set of 4-sub-slices from a sub-slice in a first tile column to a sub-slice in a 4th tile column sequentially. The first set of 4 sub-slices sequentially includes Sub-slices 0 to 3. The second set of 4 sub-slices sequentially includes Sub-slices 4 to 7, the third set of 4 sub-slices sequentially includes Sub-slices 8 to 11, and the fourth set of 4 sub-slices sequentially includes Sub-slices 12 to 15. The video decoder may decode the first set of 4 sub-slices sequentially from Sub-slice 0 in the first tile column to Sub-slice 3 in the 4th tile column. The decoding order of the second to the fourth sets of 4 sub-slices may be similar to the first set of 4 sub-slices. Steps S903 to S907 are used to decode each sub-slice, the processor decodes the k sets of Q sub-slices from the set of Q sub-slices in the first row of tiles to the set of Q sub-slices in the last row of tiles sequentially, explanations therefor are similar to the loops in the FIG. 4, and will not be repeated here for brevity.

FIG. 10 shows another low latency decoding order for picture with tile columns C0 to C3, tile rows R0 to R4, various sizes of Sub-slices 0 to 14, and the video decoder also has only 1 processor. Sub-slice 0 contains 3 CTUs/SBs, Sub-slice 1 contains 6 CTUs/SBs, Sub-slice 2 contains 4 CTUs/SBs, Sub-slice 3 contains 6 CTUs/SBs, Sub-slice 4 contains 11 CTUs/SBs, Sub-slice 5 contains 13 CTUs/SBs, Sub-slice 6 contains 4 CTUs/SBs, Sub-slice 7 contains 2 CTUs/SBs, Sub-slice 8 contains 2 CTUs/SBs, Sub-slice 9 contains 13 CTUs/SBs, Sub-slice 10 contains 16 CTUs/SBs, Sub-slice 11 contains 3 CTUs/SBs, Sub-slice 12 contains 8 CTUs/SBs, Sub-slice 13 contains 5 CTUs/SBs, and Sub-slice 14 contains 8 CTUs/SBs.

The method 9 is now explained with reference to the picture frame in FIG. 10. In FIG. 10, Q=4, S=15, k=3. The method 9 may be adopted by a single-processor video decoder, and may be used to define sub-slices without defining a sub-picture in the picture. The video decoder partitions 4 tile columns into 15 sub-slices (Step S901). The 15 sub-slices are non-overlapping with each other and may include 3 sets of 4 sub-slices. The video decoder may decode each set of 4-sub-slices from a sub-slice in the tile column C0 to a sub-slice in the tile column C3 sequentially. The first set of 4 sub-slices sequentially includes Sub-slices 0 to 3. The second set of 4 sub-slices sequentially includes Sub-slices 4 to 7, and the third set of 4 sub-slices sequentially includes Sub-slices 8 to 11. The video decoder may decode the first set of 4 sub-slices sequentially from Sub-slice 0 in the tile column C0 to Sub-slice 3 in the tile column C3. The decoding order of the second to the third sets of 4 sub-slices may be similar to the first set of 4 sub-slices. The S sub-slices may further contain r sub-slices in w tile columns of the Q tile columns, r>=w, r, w being positive integers. In FIG. 10, Q=4, S=15, r=3, w=2. In the embodiment, the 15 sub-slices further contains Sub-slice 12 and 14 in the tile column C0, and Sub-slice 13 in the tile column C3. The processor decodes Sub-slice 12, 13, and 14 after decoding the 3 sets of 4 sub-slices (Sub-slice 0 to Sub-slice 11). That is, the processor decodes the 3 sub-slices after the 3 sets of Q sub-slices. The decoding order follows Sub-slice 0, Sub-slice 1, Sub-slice 2. . . and terminated after Sub-slice 14 is decoded. FIG. 10 is provided as an example, and should not be interpreted as limiting the configurations of the tile rows, the tile columns, and the sub-slices.

FIG. 11 shows another low latency decoding order for picture with tile column=4, tile row=2, sub-slice width=tile width, sub-slice height=1CTU/SB, and the video decoder has 2 processors. If the video decoder has the capability of parallel processing, in this example with 2 processors and can decode 2 tiles at the same time. The blank background CTU/SB and the dotted shading CTU/SB are decoded by different processors. The decoding order follows the arrow direction. Every sub-slice is a rectangle, and the widths of the sub-slices are the widths of the tile and the heights of the sub-slices are one CTU/SB high, and each processor is decoding in CTU/SB raster order.

FIG. 12 shows another low latency decoding order for picture with tile column=4, tile row=2, sub-slice width=tile width, various sub-slice height, and the video decoder has 2 processors. The blank background CTU/SB and the dotted shading CTU/SB are decoded by different processors. The decoding order follows the arrow direction. The sub-slices are rectangles, and the widths of the sub-slices are the tile widths. The heights of the sub-slices are not limited to 1 CTU/SB. A first processor decodes the sub-picture on the blank background in the tile raster order, and the heights of the corresponding sub-slices following the decoding order are 1 CTU/SB, 3 CTU/SB, 2 CTU/SB, and 2 CTU/SB, respectively. A second processor decodes the sub-picture on the dotted shading in the tile raster order, the heights of the corresponding sub-slices following the decoding order are 3 CTU/SB, 1 CTU/SB, 1 CTU/SB, and 3 CTU/SB, respectively.

FIG. 3 shows another embodiment of the present invention, and the video decoder has 2 processors. The blank background CTU/SB and the dotted shading CTU/SB are decoded by different processors. The sizes of the sub-slice decoded by the processor on the left side are shown as follows. Sub-slice 0-0 contains 3 CTUs/SBs, Sub-slice 0-1 contains 6 CTUs/SBs, Sub-slice 0-2 contains 13 CTUs/SBs, Sub-slice 0-3 contains 13 CTU or SB, Sub-slice 0-4 contains 8 CTUs/SBs, Sub-slice 0-5 contains 13 CTUs/SBs, Sub-slice 0-6 contains 8 CTUs/SBs. The sizes of the sub-slice decoded by the processor on the right side are shown as follows. Sub-slice 1-0 contains 4CTUs/SBs, Sub-slice 1-1 contains 6 CTUs/SBs, Sub-slice 1-2 contains 4 CTUs/SBs, Sub-slice 1-3 contains 2 CTUs/SBs, Sub-slice 1-4 contains 13 CTU or SB, Sub-slice 1-5 contains 3 CTUs/SBs, Sub-slice 1-6 contains 3 CTUs/SBs, Sub-slice 1-7 contains 3 CTUs/SBs, Sub-slice 1-8 contains 2 CTUs/SBs.

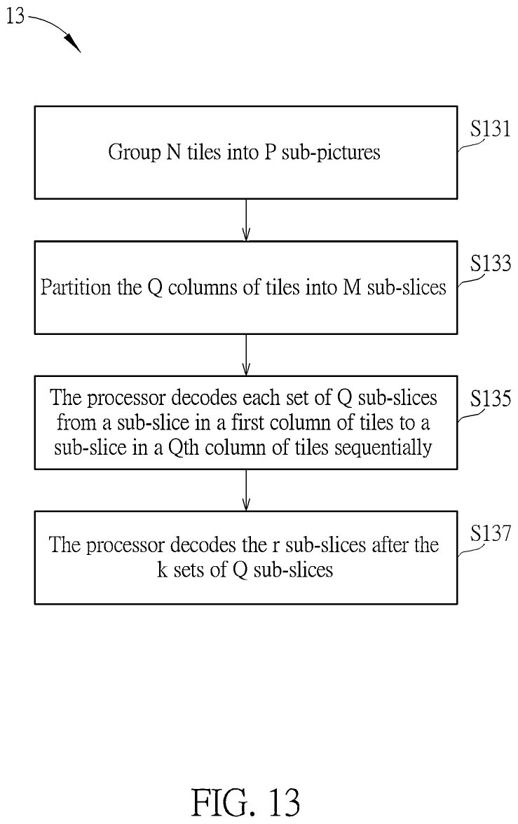

FIG. 13 is a flowchart of a method 13 of decoding the picture frames from the bitstream. The video decoder may utilize the method 13 of decoding the picture frame in FIG. 3 from a bitstream. The method 13 includes Steps S131 to S137. Any reasonable step change or adjustment is within the scope of the disclosure. Steps S131 to S137 are detailed as follows:
Step S131: Group N tiles into P sub-pictures, the P sub-pictures being non-overlapping with each other, a first sub-picture of the P sub-pictures comprising Q columns of tiles, N being an integer exceeding 1, N being an integer exceeding 1, P, Q being positive integers;
Step S133: Partition the Q columns of tiles into M sub-slices, the M sub-slices containing k sets of Q sub-slices, each set of Q sub-slices being partitioned in the Q columns, the M sub-slices being non-overlapping with each other, M being an integer exceeding 1, k being a positive integer;
Step S135: The processor decodes each set of Q sub-slices from a sub-slice in a first column of tiles to a sub-slice in a Qth column of tiles sequentially;
Step S137: The processor decodes the r sub-slices after the k sets of Q sub-slices.

The method 13 is now explained with reference to the picture frame in FIG. 3. The method 13 may be adopted by a dual-processor video decoder. In FIG. 3, N=8, P=2, the video decoder groups 8 tiles into 2 sub-pictures (Sub-picture 0 and Sub-picture 1), Sub-picture 0 being decoded by a first processor and Sub-picture 1 being decoded by a second processor (Step S131). For simplicity, the following discussion will address decoding of Sub-picture 0 (blank background), and decoding of the Sub-picture 1 (dotted shading) may be performed according to the similar principle.

In Sub-picture 0, Q=2, M=7, Sub-picture 0 includes 2 tile columns, and the 2 tile columns are partitioned into 7 sub-slices (Sub-slices 0-0 to 0-6), each of the 7 sub-slices being non-overlapping with each other (Step S133). Further, k=3, the 7 sub-slices contain 3 sets of 2sub-slices, each set of 2 sub-slices being partitioned in the 2 tile columns. The first set of 2sub-slices includes Sub-slice 0-0 and Sub-slice 0-1, the second set of 2 sub-slices includes Sub-slice 0-2 and Sub-slice 0-3, and the third set of 2 sub-slices includes Sub-slice 0-4 and Sub-slice 0-5. The first processor decodes each set of 2 sub-slices from a sub-slice in the first tile column to a sub-slice in the Qth tile column sequentially (Step S135). In the embodiment, the first processor sequentially decodes the first set of 2 sub-slices from Sub-slice 0-0 to Sub-slice 0-1, then decodes the second set of 2 sub-slices from Sub-slice 0-2 to Sub-slice 0-3, and then decodes the third set of 2 sub-slices from Sub-slice 0-4 to Sub-slice 0-5.

The M sub-slices may further contain r sub-slices in w tile columns of the Q tile columns, r>=w, r, w being positive integers. In FIG. 3, the 7 sub-slices further contains Sub-slice 0-6 in the first tile column, and the first processor decodes Sub-slice 0-6 after decoding the 3 sets of 2 sub-slices (Sub-slice 0-0 to Sub-slice 0-5) (Step 137). That is, the first processor decodes the r sub-slices after the k sets of Q sub-slices.

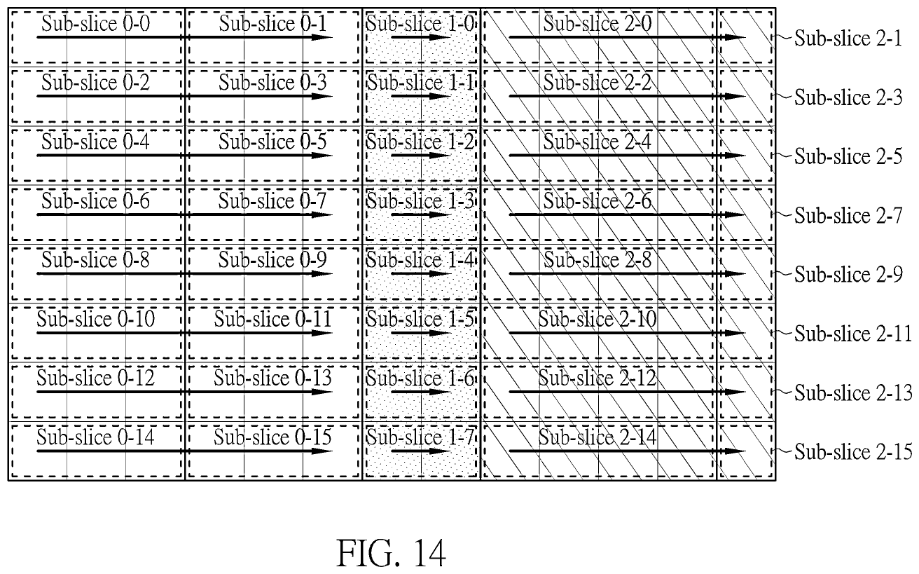

FIG. 14 shows another low latency decoding order for picture with tile column=5, tile row=1, sub-slice width=tile width, sub-slice height=1CTU/SB, and the video decoder having 3 processors. The picture frame is divided into 3 sub-pictures, each sub-picture being decoded by corresponding processors. The decoding order follows the arrow direction. The first sub-picture is represented by blank background and is partitioned into Sub-slices 0-0 to 0-15, the second sub-picture is represented by dotted shading and is partitioned into Sub-slices 1-0 to 1-7, and the third sub-picture is represented by slash shading and is partitioned into Sub-slices 2-0 to 2-15. The width of each sub-slice is the width of the tile and the height is one CTU/SB. The first processor may decode the first sub-picture in the order of Sub-slices 0-0 to 0-15, The second processor may decode the second sub-picture in the order of Sub-slices 1-0 to 1-7, The third processor may decode the third sub-picture in the order of Sub-slices 2-0 to 2-15, Each processor may decode each individual sub-slice in CTU/SB raster order.

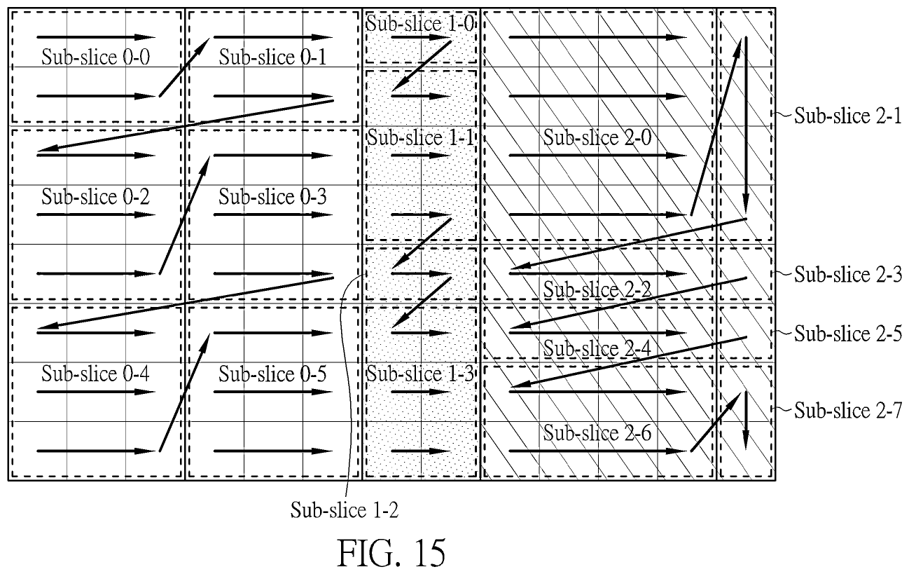

FIG. 15 shows another low latency decoding order for picture with tile column=5, tile row=1, sub-slice width=tile width, various sub-slice height, and the video decoder having 3processors. The picture frame is divided into 3 sub-pictures, each sub-picture being decoded by corresponding processors. The decoding order follows the arrow direction. The first sub-picture is represented by blank background and is partitioned into Sub-slices 0-0 to 0-5, the second sub-picture is represented by dotted shading and is partitioned into Sub-slices 1-0 to 1-3, and the third sub-picture is represented by slash shading and is partitioned into Sub-slices 2-0 to 2-7. The decoding order follows the arrow direction. The width of the sub-slice is the width of the tile, but the height of the sub-slice is not 1. The sub-slices are rectangles. The first processor may decode the first sub-picture in the order of Sub-slices 0-0 to 0-5, The second processor may decode the second sub-picture in the order of Sub-slices 1-0 to 1-3, The third processor may decode the third sub-picture in the order of Sub-slices 2-0 to 2-7, Each processor may decode each individual sub-slice in CTU/SB raster order. The heights of Sub-slices 0-0 and 0-1 are 2 CTUs/SBs, the heights of Sub-slices 0-2, 0-3, 0-4, 0-5, 1-1, and 1-3 are 3 CTUs/SBs, the heights of Sub-slices 1-0, 1-2, 2-2, 2-3, 2-4, and 2-5 are 1 CTU/SB, and the heights of Sub-slices 2-0 and 2-1 are 4 CTUs/SBs.

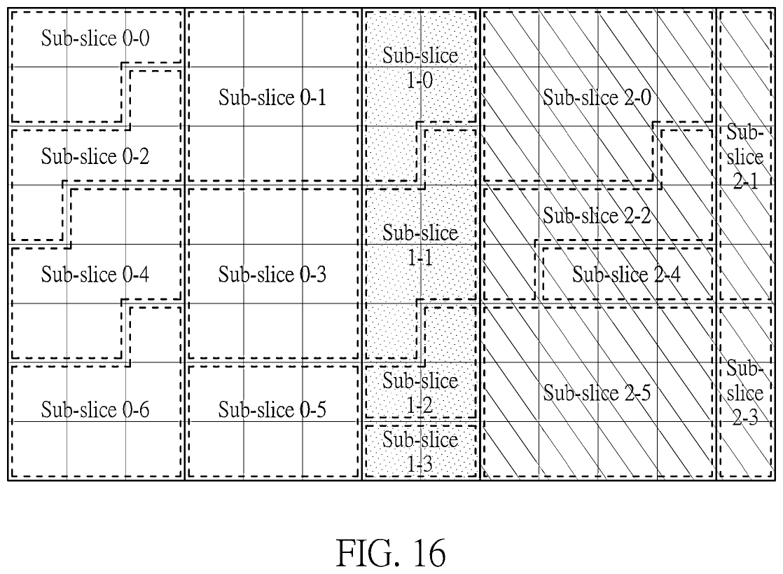

FIG. 16 shows another low latency decoding order for picture with tile column=5, tile row=1, various size sub-slices, and the video decoder having 3 processors. The picture frame is divided into 3 sub-pictures, each sub-picture being decoded by corresponding processors. The first sub-picture is represented by blank background and is partitioned into Sub-slices 0-0 to 0-6, the second sub-picture is represented by dotted shading and is partitioned into Sub-slices 1-0 to 1-3, and the third sub-picture is represented by slash shading and is partitioned into Sub-slices 2-0 to 2-5. The sub-slices in FIG. 16 comprise CTUs arranged in a non-rectangular shape. The first processor may decode the first sub-picture in the order of Sub-slices 0-0 to 0-6, The second processor may decode the second sub-picture in the order of Sub-slices 1-0 to 1-3, The third processor may decode the third sub-picture in the order of Sub-slices 2-0 to 2-5, Each processor may decode each individual sub-slice in CTU/SB raster order.

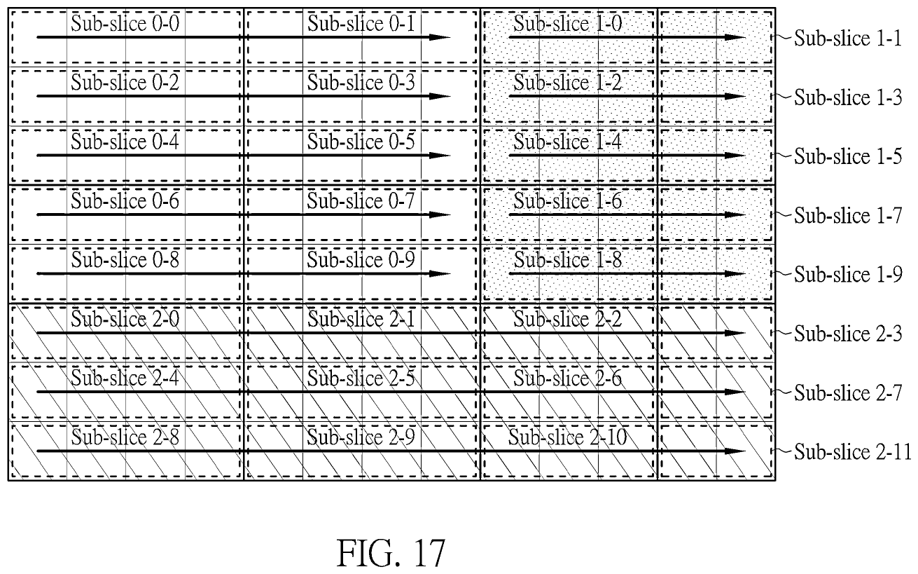

FIG. 17 shows another low latency decoding order for picture with tile column=4, tile row=3, sub-slice width=tile width, sub-slice height=1 CTU/SB, and the video decoder having 3 processors. The picture frame is divided into 3 sub-pictures, each sub-picture being decoded by corresponding processors. The first sub-picture is represented by blank background and is partitioned into Sub-slices 0-0 to 0-9, the second sub-picture is represented by dotted shading and is partitioned into Sub-slices 1 -0 to 1-9, and the third sub-picture is represented by slash shading and is partitioned into Sub-slices 2-0 to 2-11. The first processor may decode the first sub-picture in the order of Sub-slices 0-0 to 0-9, The second processor may decode the second sub-picture in the order of Sub-slices 1-0 to 1-9, The third processor may decode the third sub-picture in the order of Sub-slices 2-0 to 2-11. The decoding order follows the arrow direction. The width of each sub-slice is the width of the tile, and the height is one CTU/SB. Each processor may decode each individual sub-slice in CTU/SB raster order.

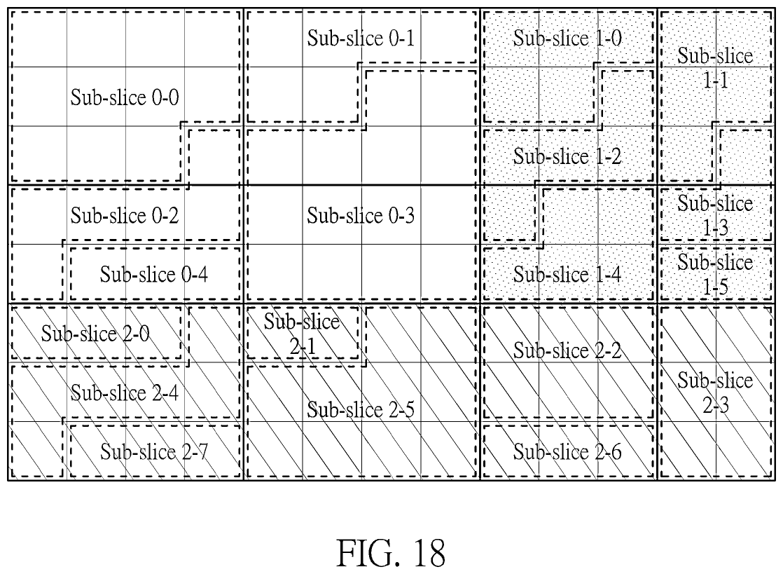

FIG. 18 shows another low latency decoding order for picture with tile column=4, tile row=3, various size sub-slices, and the video decoder having 3 processors. The picture frame is divided into 3 sub-pictures, each sub-picture being decoded by corresponding processors. The first sub-picture is represented by blank background and is partitioned into Sub-slices 0-0 to 0-4, the second sub-picture is represented by dotted shading and is partitioned into Sub-slices 1-0 to 1-5, and the third sub-picture is represented by slash shading and is partitioned into Sub-slices 2-0 to 2-7. The sub-slices in FIG. 18 comprise CTUs arranged in a non-rectangular shape. The first processor may decode the first sub-picture in the order of Sub-slices 0-0 to 0-4, The second processor may decode the second sub-picture in the order of Sub-slices 1-0 to 1-5, The third processor may decode the third sub-picture in the order of Sub-slices 2-0 to 2-7, Each processor may decode each individual sub-slice in CTU/SB raster order.

The method 13 may be applied to the embodiments in FIGS. 11-12, 14-18.

FIG. 19 shows another low latency decoding order for picture with tile column=4, tile row=3, various size sub-slices, and the video decoder having 3 processors. The picture frame is divided into 3 sub-pictures, each sub-picture being decoded by corresponding processors. The first sub-picture is represented by blank background and is partitioned into Sub-slices 0-0 to 0-3, the second sub-picture is represented by dotted shading and is partitioned into Sub-slices 1-0 to 1-10, and the third sub-picture is represented by slash shading and is partitioned into Sub-slices 2-0 to 2-5. The sub-slices in FIG. 19 comprise CTUs arranged in a non-rectangular shape. The first processor may decode the first sub-picture in the order of Sub-slices 0-0 to 0-3, The second processor may decode the second sub-picture in the order of Sub-slices 1-0 to 1-10, The third processor may decode the third sub-picture in the order of Sub-slices 2-0 to 2-5, Each processor may decode each individual sub-slice in CTU/SB raster order.

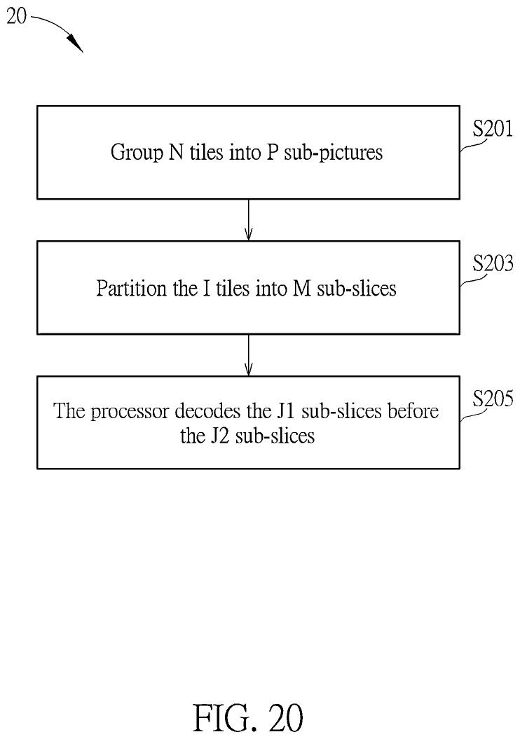

FIG. 20 is a flowchart of a method 20 of decoding the picture frames from the bitstream. The video decoder may utilize the method 20 of decoding the picture frame in FIG. 19 from a bitstream. The method 20 includes Steps S201 to S205, detailed as follows:
Step S201: Group N tiles into P sub-pictures, the P sub-pictures being non-overlapping with each other, a sub-picture of the P sub-pictures comprising I tiles distributed in Q columns of tiles, N being an integer exceeding 1, I, P, Q being positive integers;
Step S203: Partition the I tiles into M sub-slices, the I tiles containing J1 sub-slices on an a-th row of the I tiles and J2 sub-slices on an (a+h)-th row of the I tiles, the M sub-slices being non-overlapping with each other, h, M, a, J1, J2 being positive integers;
Step S205: The processor decodes the J1 sub-slices before the J2 sub-slices.

The method 20 is now explained with reference to the picture frame in FIG. 19. The method 20 may be adopted by a triple-processor video decoder. In FIG. 19, N=12, P=3, the video decoder groups the 12 tiles into 3 sub-pictures (Sub-picture 0, Sub-picture 1, and Sub-picture 2), Sub-picture 0 being decoded by a first processor, Sub-picture 1 being decoded by a second processor, and Sub-picture 2 being decoded by a third processor (Step S201). For Sub-picture 0, Q=2, I=3, Sub-picture 0 includes 3 tiles distributed in 2 tile columns. For Sub-picture 1, Q=3, I=5, Sub-picture 1 includes 5 tiles distributed in 3 tile columns. For Sub-picture 2, Q=3, I=3, Sub-picture 2 includes 3 tiles distributed in 3 tile columns. For simplicity, the following discussion will address decoding of Sub-picture 3 (slash shading), and decoding of Sub-picture 0 (blank background) and Sub-picture 1 (dotted shading) may be performed according to the similar principle.

Further, in Step S203, M=6, the 3 tiles are partitioned into 6 sub-slices (Sub-slices 2-0 to 2-5), each of the 6 sub-slices being non-overlapping with each other. Furthermore, a=1, J1=4, h=1, J2=2, the 2 tiles on the first tile row of Sub-picture 2 contain 4 sub-slices (Sub-slice 2-0 to Sub-slice 2-3), and 1 tile on the second tile row of Sub-picture 2 contains 2 sub-slices (Sub-slice 2-4 and Sub-slice 2-5). The J1 sub-slices contains k1 sets of Q1 sub-slices, and the J2 sub-slices contains k2 sets of Q2 sub-slices, k1, k2, Q1, Q2 being positive integers less than or equal to Q. As shown in FIG. 19, k1=2, Q1=2, Sub-slice 2-0 to Sub-slice 2-3 contains the first set of 2 sub-slices (Sub-slice 2-0 and Sub-slice 2-1) and the second set of 2 sub-slices (Sub-slice 2-2 and Sub-slice 2-3). Further, k2=0, Q2=0. In Step S205, the processor decoding the J1 sub-slices before the J2 sub-slices. In FIG. 19, the third processor decodes Sub-slice 2-0 to Sub-slice 2-3 before Sub-slice 2-4 and Sub-slice 2-5, following a top-to-bottom tile order. The processor decodes each set of 2 sub-slices from a sub-slice in the first tile column to a sub-slice in the last tile column sequentially. The decoding order in FIG. 19 may be the first set of 2 sub-slices (Sub-slices 2-0 and 2-1), and the second set of 2 sub-slices (Sub-slices 2-2 and 2-3). The J1 sub-slices may further contain r1 sub-slices in w1 columns of the Q1 columns, r1>=w1, r1, w1 being integers; and the J2 sub-slices may further contain r2 sub-slices in w2 columns of the Q2 columns, r2>=w2, r2, w2 being integers. In FIG. 19, r1=0, w1=0, r2=2, w2=1, the second tile row of Sub-picture 2 contains Sub-slice 2-4 and Sub-slice 2-5, and the third processor may decode Sub-slice 2-4 and Sub-slice 2-5 sequentially after decoding the 2 sets of 2 sub-slices (Sub-slice 2-0 to Sub-slice 2-3). The processor may decode the r1 sub-slices after the k1 sets of Q1 sub-slices; and decode the r2 sub-slices after the k2 sets of Q2 sub-slices.

The following paragraphs address how the display latency is affected in various embodiments.

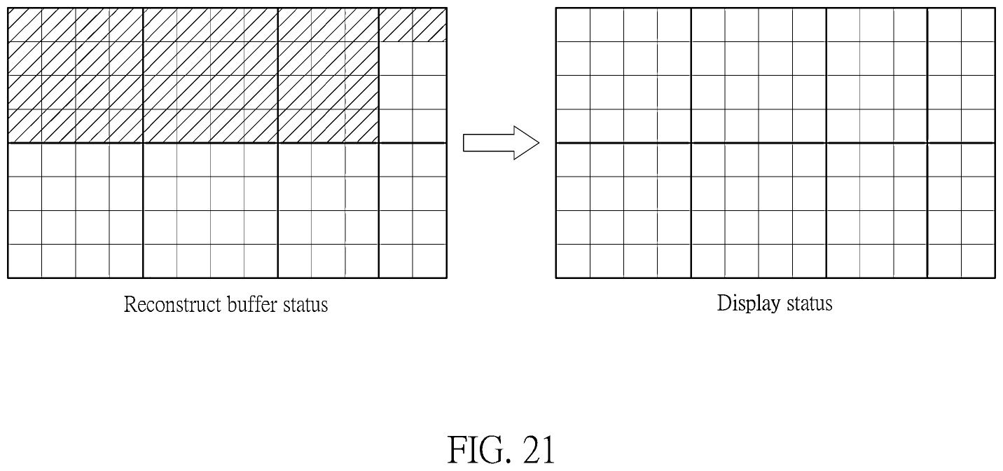

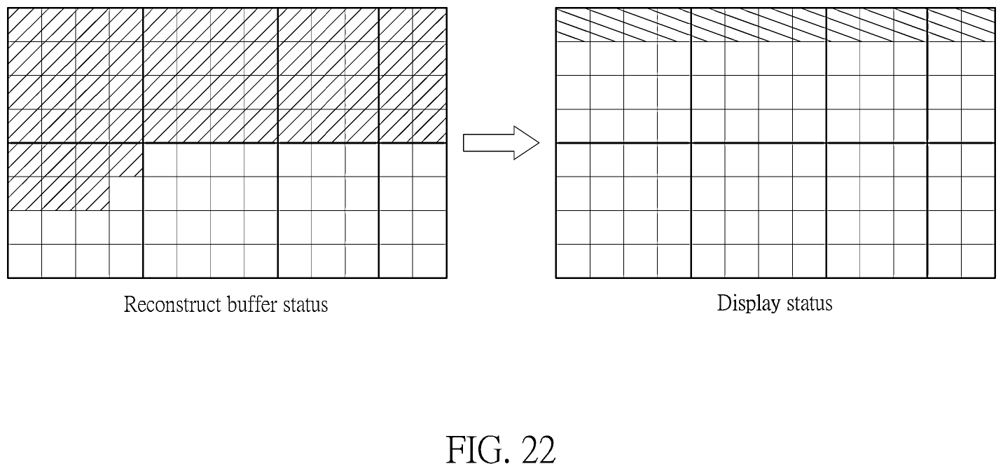

In FIGS. 21 to 24, a picture is partitioned into 4 tile columns and 2 tile rows, and is decoded in the normal tile order, with the thick lines marking the tiles, and the thin lines marking the CTUs/SBs. In FIGS. 21 to 22, the pictures on the left show the status of the reconstruct buffer, with the shaded squares representing the CTUs/SBs having been decoded and buffered, and the blank squares representing the CTUs/SBs not yet being decoded. Further, the pictures on the right in FIGS. 21 to 22 show the status of the display driver, with the shaded squares representing the CTUs/SBs having been displayed, and the blank squares representing the CTUs/SBs not yet being displayed. In order to ensure proper display of the picture, the display driver must display the decoded CTUs/SBs only after the rightmost CTU/SB has been completely decoded. Assuming that the speed of decoding each CTU/SB is fixed, the duration for decoding a CTU/SB is t=tctu, the display speed of displaying the decoded CTU/SB is also fixed, and the duration for decoding a CTU/SB is equal to the duration for displaying the equivalent number of pixels of the decoded CTU/SB. At t=t0, the duration for decoding starts. In FIG. 21, t=t0+46*tctu, 46 CTUs/SBs have been decoded and buffered in the reconstruct buffer, and the display driver may start driving pixels of the first row of the decoded CTU/SB. In FIG. 22, t=t0+59*tctu, 59 CTUs/SBs have been decoded and buffered in the reconstruct buffer, and the display driver have completed driving pixels of the first row of the decoded CTU/SB.

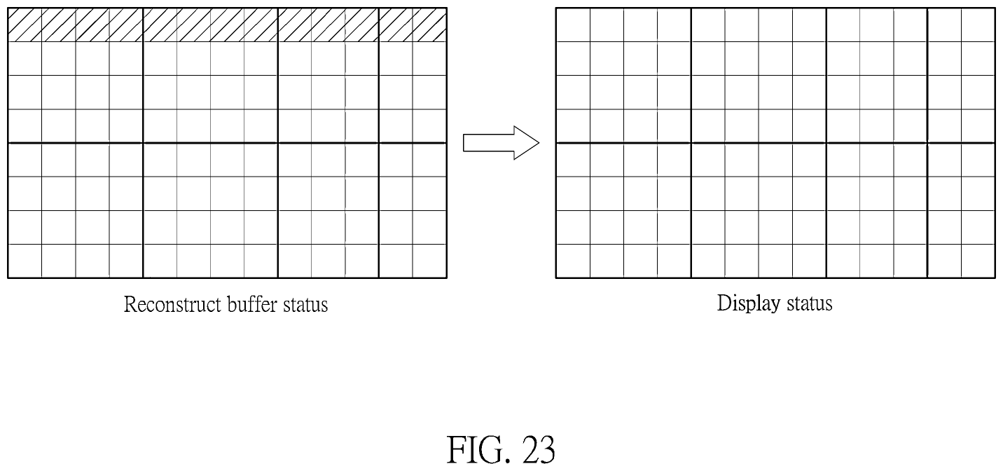

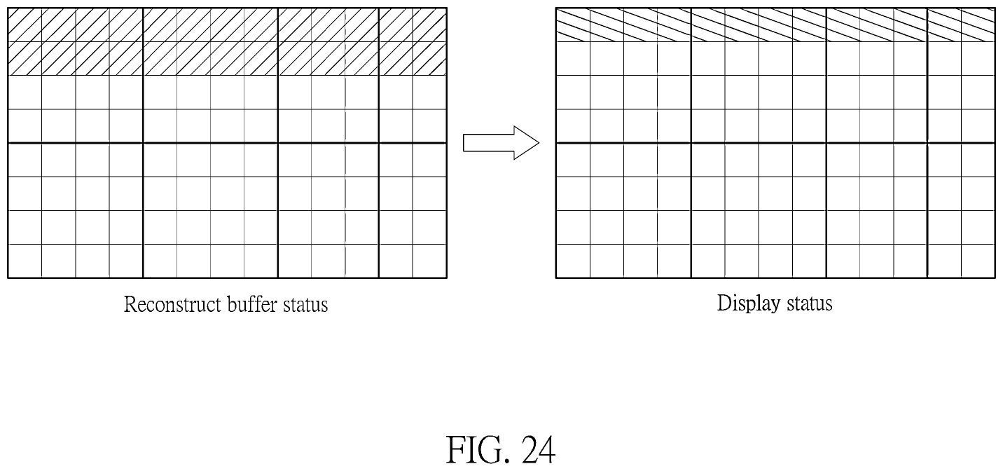

Following the example above, the picture is partitioned into tile column=4, tile row=2, and is decoded in the CTU/SB raster order using the single processor, with the width of each sub-slice being the tile width and the height of each sub-slice being the height of 1 CTU/SB. At t=t0, the decoding starts. In FIG. 23, t=t0+13*tctu, the display driver starts to drive pixels of the first row. In FIG. 24, t=t0+26*tctu, the display driver completes driving pixels of the first row.

It can be seen from FIG. 22 and FIG. 24 that decoding the picture in the CTU/SB raster order by the single processor reduces the decoding time by 33*tctu in comparison the normal tile order, while displaying the same number of pixels.

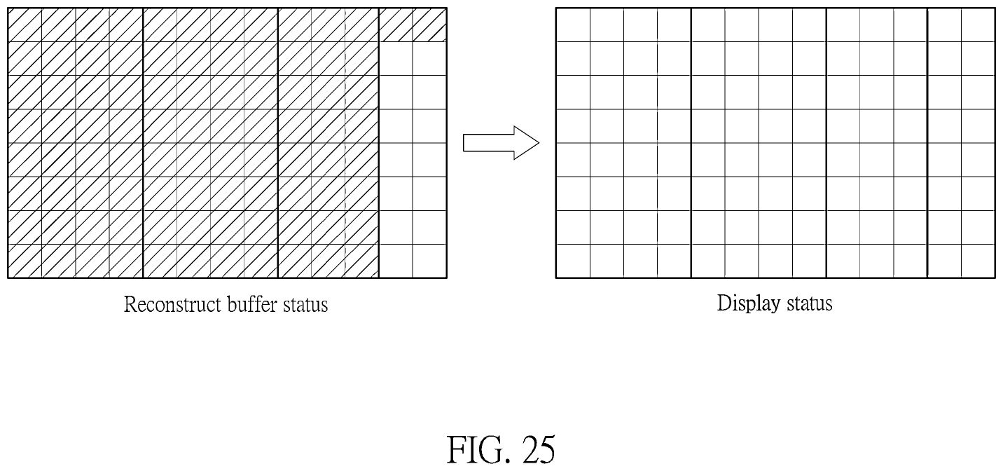

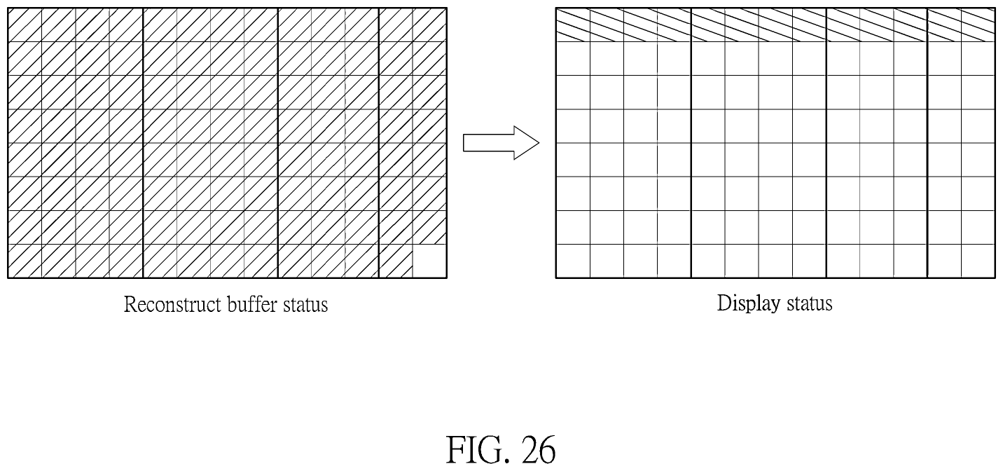

In another example in FIGS. 25 to 28, a picture is partitioned into 4 tile columns and 1 tile row, and decoded in the normal tile order. Assuming that the decoding speed of each CTU/SB is fixed, the duration for decoding a CTU/SB is t=tctu, the display speed of displaying the decoded CTU/SB is also fixed, and the duration for decoding a CTU/SB is equal to the duration for displaying the equivalent number of pixels of the decoded CTU/SB. At t=t0, the duration for decoding starts, the video decoder starts decoding. In FIG. 25, t=t0+90*tctu, the video decoder has completed decoding for the rightmost CTU/SB, and the display driver may start to output pixels of the first row of the decoded CTU/SB. In FIG. 26, t=t0+103*tctu, the shaded squares on the right represent the displayed CTU/SB.

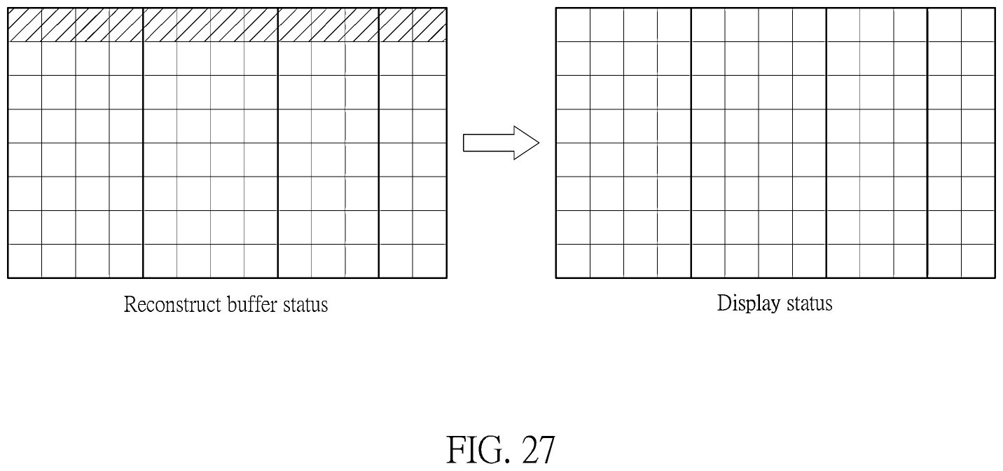

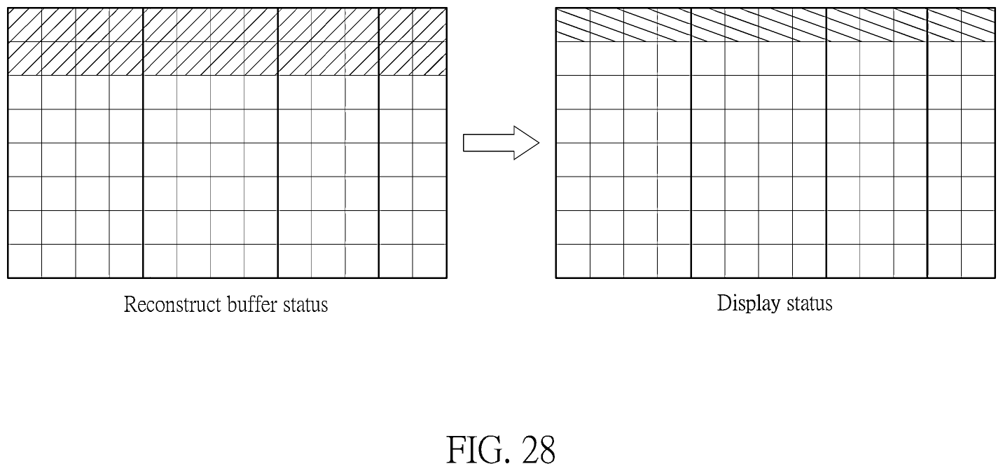

Following the above example, the picture is partitioned into 4 tile columns and 1 tile row, and is decoded in the CTU/SB raster order using the single processor, with the width of each sub-slice being the tile width and the height of each sub-slice being the height of 1 CTU/SB. At t=t0, the decoding starts. In FIG. 27, t=t0+13*tctu, the display driver starts to drive pixels of the first row. In FIG. 28, t=t0+26*tctu, the display driver completes driving pixels of the first row.

It can be seen from FIG. 26 and FIG. 28 that decoding the picture in the CTU/SB raster order by the single processor reduces the decoding time by 77*tctu in comparison the normal tile order, while displaying the same number of pixels.

The embodiments of the invention disclose video decoders and decoding methods adopting sub-slices in a picture frame to match the decoding order to the display order, thereby reducing display latency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of decoding a picture frame from a bitstream, the method comprising:
grouping N tiles of the picture frame into P sub-pictures, the P sub-pictures being non-overlapping with each other, a first sub-picture of the P sub-pictures comprising Q columns of tiles, N being an integer exceeding 1, P, Q being positive integers;
partitioning a first column of tiles of the Q columns of tiles into M sub-slices, the M sub-slices being non-overlapping with each other, M being an integer exceeding 1;
obtaining first tile information from a memory prior to decoding a current sub-slice of the M sub-slices;
a first processor decoding the current sub-slice of the M sub-slices according to the first tile information; and
storing second tile information in the memory upon completion of decoding the current sub-slice of the M sub-slices.

2. The method of claim 1, further comprising searching N tile entry points of the N tiles from the bitstream, each of the N tiles comprising a plurality of largest coding units (LCUs).

3. The method of claim 1, wherein each of the P sub-pictures comprises tiles arranged in a rectangle.

4. The method of claim 1, wherein a sub-picture of the P sub-pictures comprises tiles arranged in a non-rectangular shape.

5. The method of claim 1, wherein each of the M sub-slices comprises largest coding units (LCUs) arranged in a rectangle.

6. The method of claim 5, wherein the rectangle has a height equal to a height of an LCU, and a width equal to a width of the first column of tiles of the Q columns of tiles.

7. The method of claim 1, wherein a sub-slice of the M sub-slices comprises LCUs arranged in a non-rectangular shape.

8. The method of claim 1, wherein:
the first tile information comprises a first context, a first offset, a first range for arithmetic decoding, and a first quantity of decoded bits upon completion of decoding a previous sub-slice of the M sub-slices; and
the second tile information comprises a second context, a second offset, a second range for arithmetic decoding, and a second quantity of decoded bits upon the completion of decoding the current sub-slice of the M sub-slices.

9. The method of claim 1, wherein
a second sub-picture of the P sub-pictures comprises R columns of tiles, R being a positive integer; and
the method further comprises:
partitioning a first column of tiles of the R columns of tiles into O sub-slices, the O sub-slices being non-overlapping with each other, O being an integer exceeding 1;
obtaining third tile information from the memory prior to decoding a current sub-slice of the O sub-slices;
a second processor decoding the current sub-slice of the O sub-slices according to the third tile information; and
storing fourth tile information in the memory upon completion of decoding the current sub-slice of the O sub-slices.

10. The method of claim 1, wherein:
the M sub-slices contains k sets of Q sub-slices, and each set of Q sub-slices is partitioned in the Q columns, k being a positive integer; and
the method further comprises: a processor decoding each set of Q sub-slices from a sub-slice in a first column of tiles to a sub-slice in a Qth column of tiles sequentially.

11. The method of claim 10, wherein the processor decodes the k sets of Q sub-slices from a set of Q sub-slices in a first row of tiles to a set of Q sub-slices in a last row of tiles sequentially.

12. The method of claim 10, wherein the M sub-slices further contain r sub-slices in w columns of the Q columns, r>=w, r, w being positive integers.

13. The method of claim 12, further comprising the processor decoding the r sub-slices after the k sets of Q sub-slices.

14. The method of claim 10, wherein some of the M sub-slices occupy parts of two tiles in a same column of tiles.

15. The method of claim 1, wherein:
the first sub-picture comprises I tiles distributed in the Q columns of tiles, I being a positive integer;
the I tiles contains J1 sub-slices on an a-th row of the I tiles and J2 sub-slices on an (a+h)-th row of the I tiles, h, a, J1, J2 being positive integers; and
the method further comprises: a processor decoding the J1 sub-slices before the J2 sub-slices.

16. The method of claim 15, wherein:
the J1 sub-slices contains k1 sets of Q1 sub-slices, and the J2 sub-slices contains k2 sets of Q2 sub-slices, k1, k2, Q1, Q2 being positive integers less than or equal to Q; and
the processor decoding the J1 sub-slices before the J2 sub-slices comprises:
the processor decoding each set of Q1 sub-slices from a sub-slice in a first column of tiles in the a-th row to a sub-slice in a Q1th column of tiles in the a-th row sequentially; and
the processor decoding each set of Q2 sub-slices from a sub-slice in a first column of tiles in the (a+h)-th row to a sub-slice in a Q2th column of tiles in the (a+h)-th row sequentially.

17. The method of claim 15, wherein:
the J1 sub-slices further contain r1 sub-slices in w1 columns of the Q1 columns, r1>=w1, r1, w1 being integers; and
the J2 sub-slices further contain r2 sub-slices in w2 columns of the Q2 columns, r2>=w2, r2, w2 being integers.

18. The method of claim 17, further comprising:
the processor decoding the r1 sub-slices after the k1 sets of Q1 sub-slices; and
the processor decoding the r2 sub-slices after the k2 sets of Q2 sub-slices.

19. A video decoder of decoding a picture frame from a bitstream, the video decoder comprising:
a sub-picture circuit to group N tiles of the picture frame into P sub-pictures, the P sub-pictures being non-overlapping with each other, a first sub-picture of the P sub-pictures comprising Q columns of tiles, N being an integer exceeding 1, P, Q being positive integers;
a sub-slice circuit coupled to the sub-picture circuit to partition a first column of tiles of the Q columns of tiles into M sub-slices, the M sub-slices being non-overlapping with each other, M being an integer exceeding 1; and
a memory controller coupled to a memory to obtain first tile information from the memory prior to decoding a current sub-slice of the M sub-slices; and
a first processor coupled to the sub-slice circuit and the memory controller to decode the current sub-slice of the M sub-slices according to the first tile information;
wherein the memory controller further stores second tile information in the memory upon completion of decoding the current sub-slice of the M sub-slices.

20. The video decoder of claim 19, further comprising:
a search circuit coupled to the processor to search N tile entry points of the N tiles from the bitstream, and output the N tile entry points to the processor, each of the N tiles comprising a plurality of largest coding units (LCUs).

21. The video decoder of claim 19, wherein each of the P sub-pictures comprises tiles arranged in a rectangle.

22. The video decoder of claim 19, wherein each of the M sub-slices comprises LCUs arranged in a rectangle.

23. The video decoder of claim 22, wherein the rectangle has a height equal to a height of an LCU, and a width equal to a width of the first column of tiles.

24. The video decoder of claim 19, wherein a sub-slice of the M sub-slices comprises LCUs arranged in a non-rectangular shape.

25. The video decoder of claim 19, wherein:
the first tile information comprises a first context, a first offset, a first range for arithmetic decoding, and a first quantity of decoded bits upon completion of decoding an ending LCU of a previous sub-slice of the M sub-slices; and
the second tile information comprises a second context, a second offset, a second range for arithmetic decoding, and a second quantity of decoded bits upon the completion of decoding the ending LCU in the current sub-slice of the M sub-slices.

26. The video decoder of claim 19, wherein:
a second sub-picture of the P sub-pictures comprises R columns of tiles, R being a positive integer; and
the sub-slice circuit further partitions a first column of tiles of the R columns of tiles into O sub-slices, the O sub-slices being non-overlapping with each other, O being an integer exceeding 1;
the memory controller further obtains third tile information from the memory prior to decoding a current sub-slice of the O sub-slices;
the video decoder further comprises a second processor coupled to the sub-slice circuit and the memory controller to decode the current sub-slice of the O sub-slices according to the third tile information; and
the memory controller further stores fourth tile information in the memory upon completion of decoding the current sub-slice of the O sub-slices.

27. A method of decoding a picture frame from a bitstream, the method comprising:
partitioning Q columns of tiles into S sub-slices, the S sub-slices containing k sets of Q sub-slices, each set of Q sub-slices being partitioned from a first column to a Qth column, the S sub-slices being non-overlapping with each other, Q, k being positive integers, S being an integer exceeding 1;
obtaining first tile information from a memory prior to decoding a current sub-slice of the S sub-slices;
a processor decoding the current sub-slice of the S sub-slices according to the first tile information; and
storing second tile information in the memory upon completion of decoding the current sub-slice of the S sub-slices.

28. The method of claim 27, further comprising the processor decodes each set of Q sub-slices from a sub-slice in a first column of tiles to a sub-slice in a Qth column of tiles sequentially.

29. The method of claim 27, wherein the processor decodes the k sets of Q sub-slices from a set of Q sub-slices in a first row of tiles to a set of Q sub-slices in a last row of tiles sequentially.

30. The method of claim 27, wherein the S sub-slices further contain r sub-slices in w columns of the Q columns, r>=w, r, w being positive integers.

31. The method of claim 30, wherein the processor decodes the r sub-slices after the k sets of Q sub-slices.

32. The method of claim 27, wherein some of the S sub-slices occupy parts of two tiles in a same column of tiles.

33. The method of claim 27, wherein each of the S sub-slices comprises LCUs arranged in a rectangle.

34. The method of claim 33, wherein the rectangle has a height equal to a height of an LCU, and a width equal to a width of a column of tiles.

35. The method of claim 27, wherein a sub-slice of the S sub-slices comprises LCUs arranged in a non-rectangular shape.

36. The method of claim 27, wherein:
the first tile information comprises a first context, a first offset, a first range for arithmetic decoding, and a first quantity of decoded bits upon completion of decoding a previous sub-slice of the S sub-slices; and
the second tile information comprises a second context, a second offset, a second range for arithmetic decoding, and a second quantity of decoded bits upon the completion of decoding the current sub-slice of the S sub-slices.
